(19) United States
(12) Patent Application Publication
(10) Pub. No.: US 2016/0008215 A1
(43) Pub. Date: Jan. 14, 2016

(54) DEVICE FOR STIMULATING UPPER VAGINA

(71) Applicant: JEFFREY S. PFEIFFER, DECATUR, IL (US)

(72) Inventors: JEFFREY S. PFEIFFER, DECATUR, IL (US); PIERRE M. JOHNSON, DECATUR, IL (US)

(73) Assignee: JEFFREY S. PFEIFFER, DECATUR, IL (US)

(21) Appl. No.: 14/738,310

(22) Filed: Jun. 12, 2015

Related U.S. Application Data
(60) Provisional application No. 62/011,927, filed on Jun. 13, 2014.

(51) Int. Cl. A61H 19/00

(52) U.S. Cl. CPC A61H 19/40; A61H 19/44; A61H 19/50; A61H 19/34; A61H 2201/1683

(57) ABSTRACT

The present invention is generally directed a device configured to contact/stimulate a portion of the upper vagina to enhance sexual pleasure, increase the likelihood and/or intensity of orgasm, and/or increase vaginal lubrication, elasticity and/or vascularity. An upper portion of the device adjacent the cephalad end is configured to fit within the upper vagina of a woman such that an outer surface of the upper portion is in abutting contact with at least a portion of the upper vagina walls. The device is configured such that the upper portion can be moved to apply pulses of pressure against at least a portion of the upper vagina walls to stimulate erogenous zones in the region.

### CROSS-REFERENCE TO RELATED APPLICATIONS

This application is a non-provisional application claiming priority to provisional application U.S. Ser. No. 62/011,927 filed Jun. 13, 2014, incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention is generally directed to the field of sexual enhancement devices and methods for treating sexual dysfunction. In one embodiment, the invention is directed to a device configured to contact/stimulate a portion of the upper vagina to enhance sexual pleasure, increase the likelihood and/or intensity of orgasm, and/or increase vaginal lubrication, elasticity and/or vascularity. In another embodiment, the invention is directed to a two-part device for use during sexual intercourse having a cephalad end configured to contact/stimulate the upper vagina of a woman and a caudal end configured to contact/stimulate the glans of the penis.

2. Description of Related Art

Anorgasmia (the medical term for regular difficulty reaching orgasm) is a widespread medical problem for many sexually active women of all ages. The vast majority of women never reach an orgasm with vaginal intercourse alone. Most require additional external stimulation. The intensity and frequency of the orgasms, and the amount of stimulation needed to trigger orgasms varies considerably. In addition, a significant number of women cannot climax under any circumstances.

Although a number of pharmaceuticals have been developed to assist males in achieving erection, little has been done to increase the likelihood and intensity of female pleasure and orgasm, despite the large need. There are a number of different devices that can be used to enhance pleasure, but most of these are not designed for use simultaneously while having intercourse with a partner.

In addition, most of these devices focus on the outer or lower third of the vagina, targeting the well documented erogenous zones of the clitoris, which is located forward of the labia minora, and/or the Grafenberg spot (G-Spot), which is located along the anterior lower vaginal wall. Many women that achieve regular orgasms typically report that one or both of these areas are stimulated. While there is also evidence of erogenous zones in the fornices along the upper vaginal walls that surround the cervix, these areas are hard to reach for the average penis, either because of length, girth, wrong angle, or the existing cervix making it impossible to stimulate the areas of interest. Furthermore, surveys of women show that only a minority of women experience climax even with deep penetration intercourse. The premise for this disparity is that the erogenous zones in the fornices of the upper vagina are rarely stimulated even during deep penetration intercourse. The narrow spaces of the fornices are difficult for a penis to access during intercourse and are therefore rarely stimulated during normal intercourse.

Vaginal atrophy (the medical term for the thinning, drying and inflammation of the vaginal walls including loss of vascularity and elasticity) is also a widespread medical problem for sexually active women that commonly occurs after menopause due to reduced estrogen levels. Vaginal atrophy can result in painful intercourse (a condition known as “dyspareunia”) for many women which further reduces the likelihood of orgasm and desire to have intercourse.

It is the inventor's belief that stimulating the erogenous zones within the upper vagina, particularly the deep anterior fornices (or deep anterior vaginal wall for post-hysterectomy patients) will lead to increased vaginal lubrication, resulting in less pain for women suffering from vaginal atrophy. Furthermore, more frequent stimulation of these areas over time will not only increase vaginal secretions, but may also increase vascularity and elasticity thereby serving to treat vaginal atrophy and dyspareunia.

### BRIEF SUMMARY OF THE INVENTION

The present invention is directed to a device and methods of using the same wherein the device has a cephalad or upper end configured to be inserted into at least a portion of the upper vaginal region for stimulating contact with at least a portion of the vaginal walls surrounding the upper vaginal region. For purposes of this invention, the term “upper vaginal region” is defined as that portion of the vagina extending from the top or deepest part of the vagina to an area of the vagina positioned near the bottom of the cervix, preferably no more than one inch below the bottom of the cervix (for women who have had their cervix removed via hysterectomy, this would be where the bottom of the cervix was positioned prior to removal of the cervix). An upper section of the device adjacent the cephalad end is configured to correspond in shape to at least a portion of the vaginal walls in the upper vaginal region so that it can be inserted into the region with an outer surface of the upper section positioned in abutting contact against a corresponding surface of the vaginal walls surrounding the region. The configuration of the upper section of the device may be different for a woman that has a cervix versus a woman that has had her cervix removed. For women who have their cervix, the upper vaginal region encompasses the narrow channels of the fornices (anterior, posterior and lateral fornices) formed between the vaginal walls and the cervix. Thus, the upper section of the device for use by these women includes one or more extensions configured to extend into the fornices and contact one or more portions of the upper vaginal walls around the cervix. For women who have had their cervix removed, the upper vaginal region extends from the vaginal cuff to an area below where the bottom of the cervix was positioned prior to removal. Thus, the upper section of the device for use by these women may include one or more extensions configured to extend into the upper vaginal region and contact one or more portions of the upper vaginal walls or may include a bulbous or round extension configured to fit within the upper vaginal region and contact all of the surrounding walls.

It is the inventors' belief that using this device to stimulate the erogenous zones within the upper vaginal region will enhance sexual stimulation and increase the likelihood and intensity of orgasms. It will not only increase climax rates but also increase pleasure for both partners, making it a more gratifying experience that results in increased desire and more frequent sexual intercourse. In addition, it is believed use of the device to stimulate the erogenous zones within the upper vaginal region will increase vaginal lubrication and/or secretions and with repeated or regular use may also increase vaginal elasticity and vascularity. Thus, regular use of the device may serve as a method of treating vaginal atrophy and dyspareunia.

In one embodiment that can be used by women with or without a cervix, the device has a base with one or more extensions extending upwardly from the base. The extensions are configured to correspond in shape with at least a portion of the vaginal walls in the fornices such that the outer surface of the extension is positioned in abutting contact with a portion of the upper vaginal wall in the fornices. Preferably, an extension extends upwardly from a front portion of the base and is configured to fit within the anterior fornices, and/or extends upwardly from a rear portion of the base and is configured to fit within the posterior fornices. In one embodiment, an extension extends upwardly from a front portion of the base and is configured to fit within the anterior fornices and another extension extends upwardly from a rear portion of the base and is configured to fit within the posterior fornices. In another embodiment, the extension is a ring, configured to fit around the cervix and rest within the anterior, posterior and lateral fornices of the vagina.

In an alternative embodiment adapted for use by women who do not have a cervix due to removal via hysterectomy, the device may have a base with an upper extension configured to correspond in shape with at least a portion of the upper vaginal wall below the vaginal cuff and within the area in which the cervix and fornices had been positioned. This extension is positioned in abutting contact with a portion of the vaginal wall to stimulate the area. In this embodiment, the extension is a rounded or cylindrical dome shaped head, configured to rest within the upper vaginal region in abutting contact with the surrounding anterior, posterior and lateral vaginal walls.

The device may be configured for use during intercourse or for self-stimulation. In one embodiment for use during intercourse, the lower section of the device adjacent the caudal or lower end of the device is configured for contact with the glans of the penis during penetration into the vagina. When the penis comes into contact and presses against the caudal end via intercourse thrusts, the pressure applied by each thrust displaces the upper or cephalad end of the device upwardly and/or outwardly such that the extension(s) apply that pressure against the upper vaginal walls thereby stimulating erogenous zones in the region. Preferably, the device is configured such that the extension(s) move in a “come hither” motion with each thrust of the penis during intercourse. For purposes of this description, a come hither motion means a continuous rolling or wave motion wherein the extension(s) move upward, then outward applying pressure on the vaginal walls, then downward and then inward. The lower section of the device may also be made to distend laterally toward the lateral walls of the vagina when pressure is applied by the penis creating a full feeling in the vagina. This will create the perception for the female user that she's with someone extremely well endowed.

The lower section may be formed of a soft resilient material that is easily displaced upon contact such that the caudal end of the device surrounds at least a portion of the glans during penetration. In this manner when the tip of the penis or glans presses into the caudal end, the spongy material envelopes or surrounds the penis for enhanced pleasure to the male. In addition, it will seem like the vagina is much tighter as the lower section envelops the glans such that the male perception will be that he is with someone who has a tight vagina. He will also perceive that he's reaching the end of the vaginal canal. The lower section may include a central detent, slot or passageway for receiving a portion of the penis during penetration such that the soft material of the device fully surrounds a portion of the penis for enhanced pleasure of the male. The lower section may be configured only to contact or engage the glans of the penis, may extend one-half to one-third the length of the penis, or may be more elongated extending down to the introitus or outside of the vagina to envelope the entire penis.

In a preferred embodiment for use during intercourse, the device includes a base with a concave cephalad end having a bottom surface configured for abutting contact with the tip of the penis or glans. A tubular stem extends upwardly from a central portion of the base, and an arcuate cup-shaped sidewall extends upwardly and outwardly from the stem. Elongated valley-shaped openings are formed in the sidewall and stem at each side of the device to divide the upwardly extending sidewall into front and rear extensions. The front and rear extensions are configured such that an upper portion of each can fit within the anterior fornices and posterior fornices respectively of the female user (if she has a cervix) and rest in abutting contact with portions of the vaginal walls in the fornices. The extensions may also be configured to pivot laterally outward at a pivot point, such as at the stem, when the bottom surface of the base is pushed upward by the penis. This lateral outward movement causes the front and rear extensions to apply increased pressure against the vaginal walls of the anterior and posterior fornices respectively with each thrust of the penis. During intercourse, this construction results in the extensions moving in a come hither motion with each thrust of the penis. The base also preferably includes a handle extending downward from the caudal end. When the handle is pulled downward to remove the device from the vagina, the front and rear extensions may be configured to be drawn together (pivoting laterally inward at the pivot point) to enable easier removal of the device.

The device of the present invention is intended to improve the pleasure that both men and women experience from intercourse. The device creates a mass effect during intercourse, applying pressure or friction to the deep erogenous zones which induce female climax and/or pleasure during intercourse with each thrust of the male penis. In contrast to a clitoral orgasm that only lasts approximately 2 seconds, is localized, and cannot be immediately restimulated due to nerve rich endings making it too uncomfortable, it is anticipated that a deep spot or posterior forniceal orgasm will be described as a “whole body” orgasm, lasting as long as 23-25 seconds, and can be immediately restimulated repeatedly. It is also believed that use of the device to stimulate the anterior forniceal area can assist in vaginal lubrication and otherwise serve to non-pharmaceutically treat women suffering from vaginal atrophy and dyspareunia. With repeated use, it is believed the device will increase the elasticity and vascularity of the vaginal walls. It is also the inventors' belief that if the upper vaginal erogenous zones can be stimulated by the device of the present invention, in addition to the lower erogenous zones that are stimulated by the penis, the likelihood of a blended or whole body orgasm will increase significantly. In addition, by stimulating these additional areas in the upper vagina, it should heighten arousal levels of both partners and hence the intensity and duration of the orgasms.

In another embodiment of the present invention intended for self-stimulation of a female user, the device has an upper section as heretofore described and an elongated body configured to extend the entire length or lumen of the vagina. The caudal end of the device may include means for grasping and/or moving the device by the user. In addition, the device may include a protrusion extending outwardly from the front of the device in an area corresponding with that of the G-spot, such that the protrusion may come into abutting contact with the G-spot when the device is positioned within the vagina. The self-stimulation device may also include a projection extending from the front of the caudal end of the device configured to rest in abutting engagement or contact with the clitoris when the device is inserted into the vagina and/or may include a projection extending from the rear of the caudal end of the device configured to rest in abutting engagement or contact with the perineum when the device is inserted into the vagina. In this manner, the device can stimulate the erogenous zones within the upper vaginal region, the G-spot, the clitoris and/or the perineum to produce a whole body or blended orgasm without the need for a partner.

In a preferred embodiment, the self-stimulation device is configured to move the upper section of the device distally and laterally, preferably in a come hither motion, to apply pulses of pressure against one or more portions of the upper vaginal walls once in place within the upper vaginal region. This movement can be effectuated by the user via movement of the caudal end of the device or via a mechanism incorporated into the device. This alternative device is particularly well adapted for use in treating vaginal atrophy and dyspareunia.

In all of the embodiments described above, it is anticipated that the exterior surface of portions of the device will be made of a soft, pliable and resilient material such that it can deform to some extent when pushed against the wall of the vagina and/or cervix so as to apply pressure, but not puncture or damage these areas. While the exterior surface of the upper section of the device needs to be relatively pliable and soft, the upper section also needs to have sufficient structure so as to retain its general shape such that it can be easily guided and inserted into the proper position within upper vaginal region resting in abutting engagement or contact with the vaginal wall and apply pressure against the walls without collapsing or folding. In one embodiment of the invention, the upper section is constructed from a single low durometer material, such as silicone, that is pliable but has sufficient firmness or rigidity to maintain its overall shape. In an alternative embodiment, the upper section is comprised of two or more materials of different durometer. For example, the exterior of the upper section may be formed of a softer, low durometer material that is easily compressed, and the inner core of the upper section may be formed of a second more firm or rigid low durometer material to support the overall shape of the upper section. Alternatively, a spring or other resilient device may be included within the upper section that enables the upper section to be compressed and extended. In a most preferred embodiment, the body of the device including the exterior surface of the upper section is formed from a first low durometer material, and a support structure made of a second low durometer material that is harder or firmer than the first material is embedded within the body. In this embodiment, the firmer structure may also include projections extending outwardly from the structure through the exterior surface of the body to stimulate the vaginal walls upon contact.

The exterior surface of the base or lower section of the device for contact with the penis may be relatively soft, spongy and/or more easily distended than the upper portion. In one embodiment, the base is constructed such that when the tip of the penis or glans comes in contact with the caudal end of the device, the caudal end will distend laterally creating a full feeling within the vagina and surround or engulf a portion of the penis, while the cephalad end will be displaced upwardly to apply pressure against the upper vaginal walls surrounding the fornices. The lower section may be formed of a very low durometer material, such as silicone, or may made from multiple materials, such as having an outer skin or shell with a fluid, gel, foam, or more rigid interior. A spring or other resilient device may also be included within the lower section that enables the lower section to be compressed and extended.

The outer surface of the device may have variable texture including protrusions and/or grooves to increase the surface area in contact with portions of the vaginal walls and to enhance the stimulation created by contact and/or friction with the wall. In addition, the device may include means for causing the device or portions thereof to vibrate, rotate, massage, spasm, quiver, expand or contract, extend or otherwise move. The device may also be filled with a lubricant that is released during use to moisten the vagina, may include means for regulating the temperature, (heating or cooling) the device to further enhance the stimulation, and/or may include audio and or illumination means.

Lastly, while the device may be made in a single size or configuration, in a preferred embodiment of the present invention, it is anticipated that the device may be made in various dimensions to better fit the specific anatomy of a user. The dimensions of various portions of the user's vagina may first be measured by a physician or other healthcare provider and these measurements can be then used to select a device having components best corresponding in size and shape to the user. Alternatively, the measurements may be used to custom manufacture a device that fits the user or a mold of the upper vaginal region or entire vagina may be made and used to manufacture a custom fit device for the user.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a device in accordance with an embodiment of the present invention for use in sexual intercourse by a female user with a cervix.

FIG. 2 is a side view of the device of FIG. 1.

FIG. 3(a) is a cross-sectional side view of the device of FIG. 1.

FIG. 3(b) is a cross-sectional side view of an alternative embodiment of the device of FIG. 1.

FIG. 4 is a cross-sectional top view of the device of FIG. 1 taken along line AA.

FIG. 5 is an in-situ view of the device of FIG. 1 shown in use.

FIG. 6 is a side plan view of an alternative embodiment of the device of FIG. 1 where the body is tapered.

FIG. 7 is a cross-sectional side view of the device of FIG. 6, without the handle.

FIG. 8 is a side view of the device of FIG. 7 showing the internal embedded ring with handle in broken lines.

FIG. 9 is a top perspective view of a device in accordance with another embodiment of the present invention for use in sexual intercourse by a female user with a cervix.

FIG. 10 is a bottom perspective view of the device of FIG. 9.

FIG. 11 is a cross-sectional side view of the device of FIG. 9.

FIG. 12 is an in-situ view of the device of FIG. 9 shown in use.

FIG. 13 is a perspective view of a device in accordance with another embodiment of the present invention for use in sexual intercourse by a female user with a cervix.

FIG. 14 is a side plan view of the device of FIG. 13.

FIG. 15 is a cross-sectional side view of the device of FIG. 13.

FIG. 16 is an in-situ view of the device of FIG. 13 shown in use.

FIG. 17 is a side view of an alternative embodiment of the device of FIG. 13 where the body is tapered.

FIG. 18 is a bottom perspective view of an alternative embodiment of the device of FIG. 13 including a tapered caudal end with fringe slivers.

FIG. 19 is a perspective view of a device in accordance with another embodiment of the present invention for use in sexual intercourse by a female user with a cervix.

FIG. 20 is a side plan view of the device of FIG. 19.

FIG. 21 is a cross-sectional side view of the device of FIG. 19.

FIG. 22 is an in-situ view of the device of FIG. 19 shown in use.

FIG. 23 is a side plan view of a device in accordance with another embodiment of the present invention for self-stimulation use by a female user with a cervix.

FIG. 24 is a cross-sectional side view of the device of FIG. 24.

FIG. 25 is a side plan view of a device in accordance with another embodiment of the present invention for self-stimulation use by a female user without a cervix.

FIG. 26 is a cross-sectional side view of the device of FIG. 25.

FIG. 27 is a side plan view of a device in accordance with another embodiment of the present invention for self-stimulation use by a female user with a cervix.

FIG. 28 is an in-situ view of the device of FIG. 27 shown in use.

FIG. 29 is a perspective view of a device in accordance with another embodiment of the present invention for use in sexual intercourse by a female user with or without a cervix.

FIG. 30 is a side view of the device of FIG. 29.

FIG. 31 is a cross sectional side view of the device of FIG. 29.

FIG. 32 is an in-situ view of the device of FIG. 29 shown in use.

FIG. 33 is a perspective view of a device in accordance with another embodiment of the present invention for self-stimulation use by a female user with or without a cervix.

FIG. 34 is a side view of the device of FIG. 33.

FIG. 35 is a front view of the device of FIG. 33.

FIG. 36 is a top view of the device of FIG. 33.

FIG. 37 is an in-situ view of the device of FIG. 33 shown in use.

FIG. 38 is an in-situ view of the device of FIG. 29 with the base formed as a handle for self-stimulation use by a female user with or without a cervix.

### DETAILED DESCRIPTION OF PREFERRED EMBODIMENTS

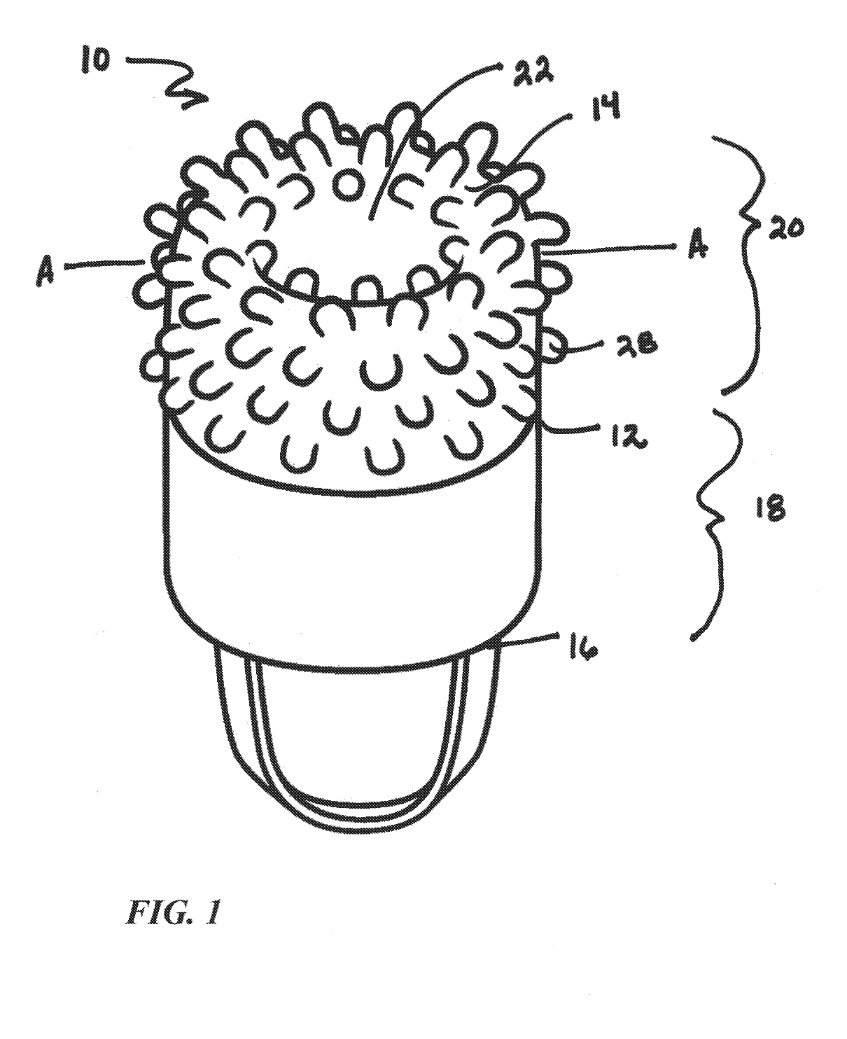

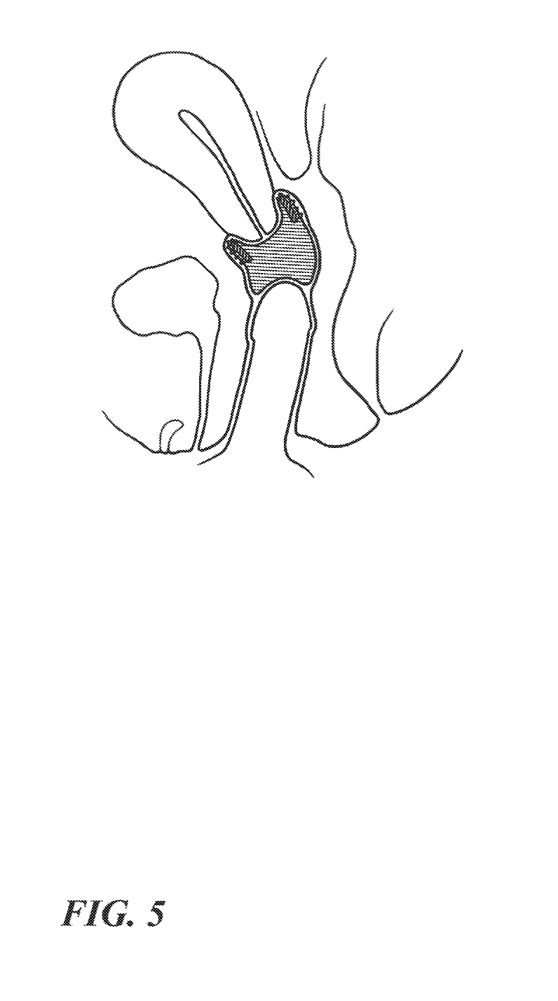

A device in accordance with a first embodiment of the present invention is generally designated in FIG. 1 by the numeral 10. Device 10 is configured for use during sexual intercourse by a female user that has a cervix. Device 10 has a cylindrical body 12 extending from an upper cephalad end 14 to a lower caudal end 16. Body 12 has a base 18 extending from lower end 16 to about a mid-point of device 10, and a ring-shaped sidewall 20 extending upwardly from the outer periphery of base 18 to upper end 14. Ring-shaped sidewall 20 defines a well-shaped recess 22 accessible through upper end 14. Ring-shaped sidewall 20 is configured to generally correspond in shape with the fornices of the user such that sidewall 20 can be inserted into the fornices of the user with the cervix received within recess 22. In this manner, the top and outer surface of sidewall 20 is positioned in abutting contact with corresponding top and side vaginal walls of the fornices (FIG. 5).

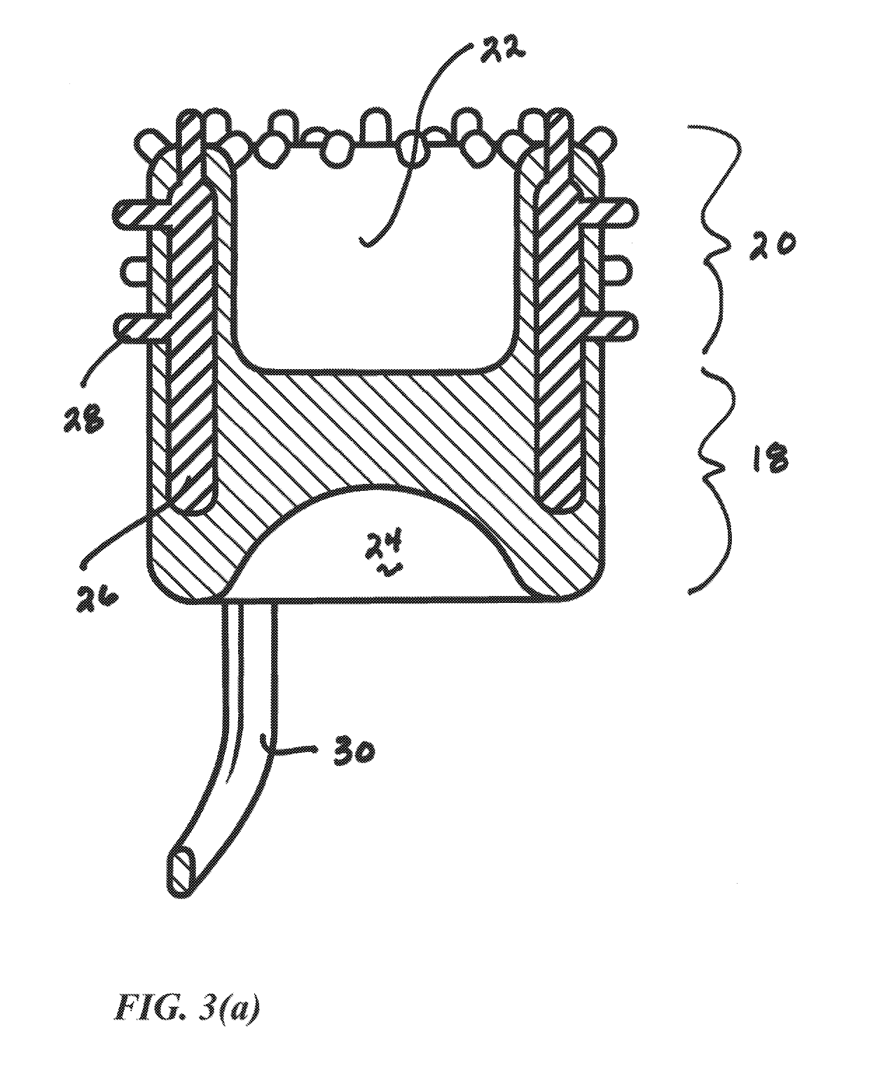

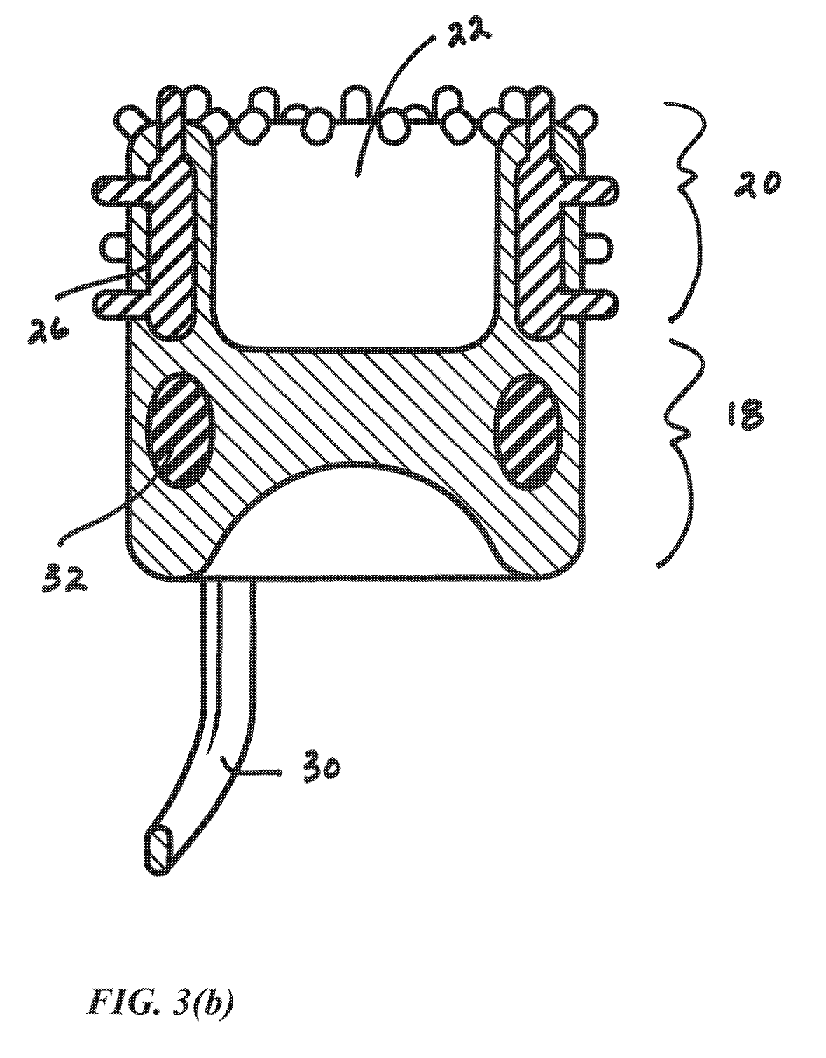

Looking to FIGS. 3a-3b, lower caudal end 16 includes a central detent 24 configured to receive the distal end or glans of the penis. While the particular embodiment shown includes detent 24, it is anticipated that the caudal end may alternatively be generally flat or may include a narrower detent or channel to receive the penis. An elongated structural ring 26 is embedded within body 12. Structural ring 26 includes projections 28 extending outwardly through the outer side and top surface of sidewall 20, and handle 30 extending outwardly through the outer surface of body 12. Projections 28 are configured to stimulate the top and side vaginal walls of the fornices. While the projections are depicted only along the outer side and top surface of the side wall, it is noted that projections could extend along the entire length of the body and/or extend from the caudal end 16 of the device. It is noted that protrusions are not included within well-shaped recess 22 in order to avoid irritating the cervix. Recess 22 serves to protect the cervix which can be irritated by contact during sexual intercourse. Handle 30 is configured to enable the user to grasp the handle with one or more fingers and remove the device when not in use. Handle 30 can be formed integrally with structural ring 26 or may alternatively be formed integrally with body 12. In addition, while the handle is shown hanging from the caudal end of the device, the handle may instead extend from any portion of the body. Furthermore, while structural ring is shaped to extend essentially parallel the outer wall of the cylindrical body, it should be appreciated that the ring could be angled or tapered outward or inward from top to bottom. The structural ring may also comprise a spring or other resilient device that enables a portion of the body to be compressed and extended.

Looking to FIG. 3b, a stimulation ring 32 is embedded within base 18 below structural ring 26. Stimulation ring includes means for enhancing stimulation of the user and her male partner. These means may include a mechanism for moving the stimulation ring such as for making the ring vibrate, quiver, or rotate and/or may include a mechanism for heating or cooling the stimulation ring. In an alternate embodiment, a mechanism may be incorporated within structural ring 26 for moving structural ring 26 and/or for heating or cooling structural ring 26.

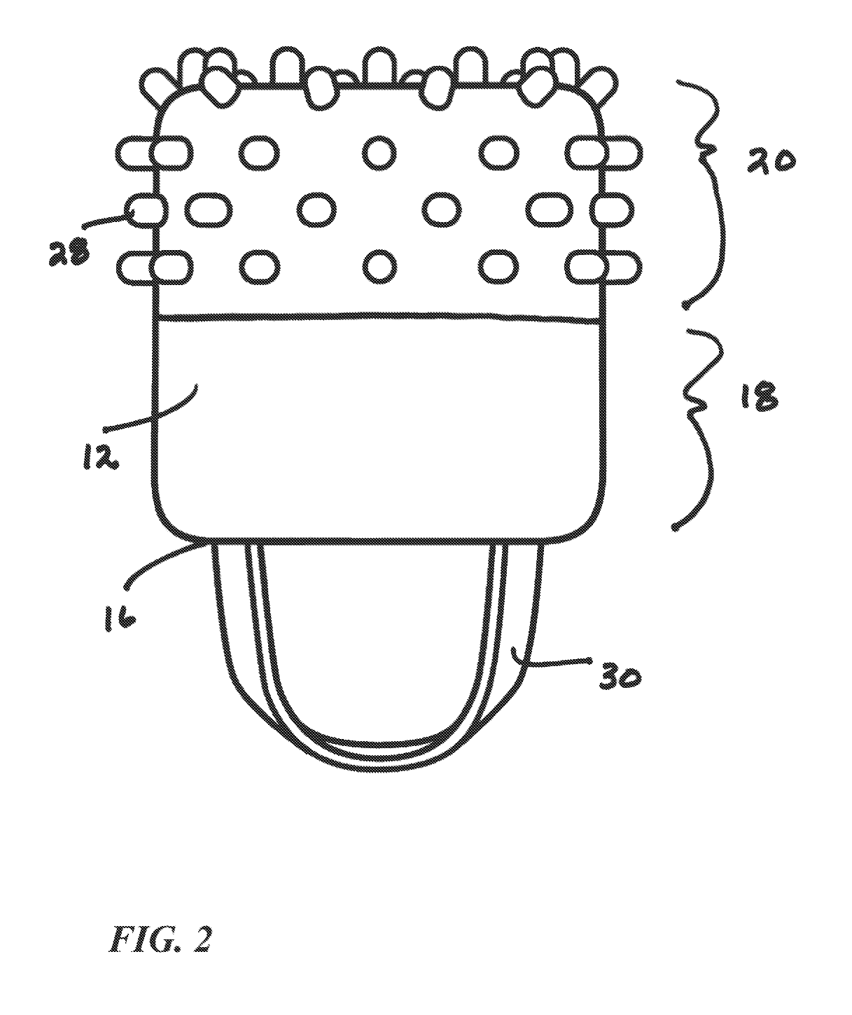

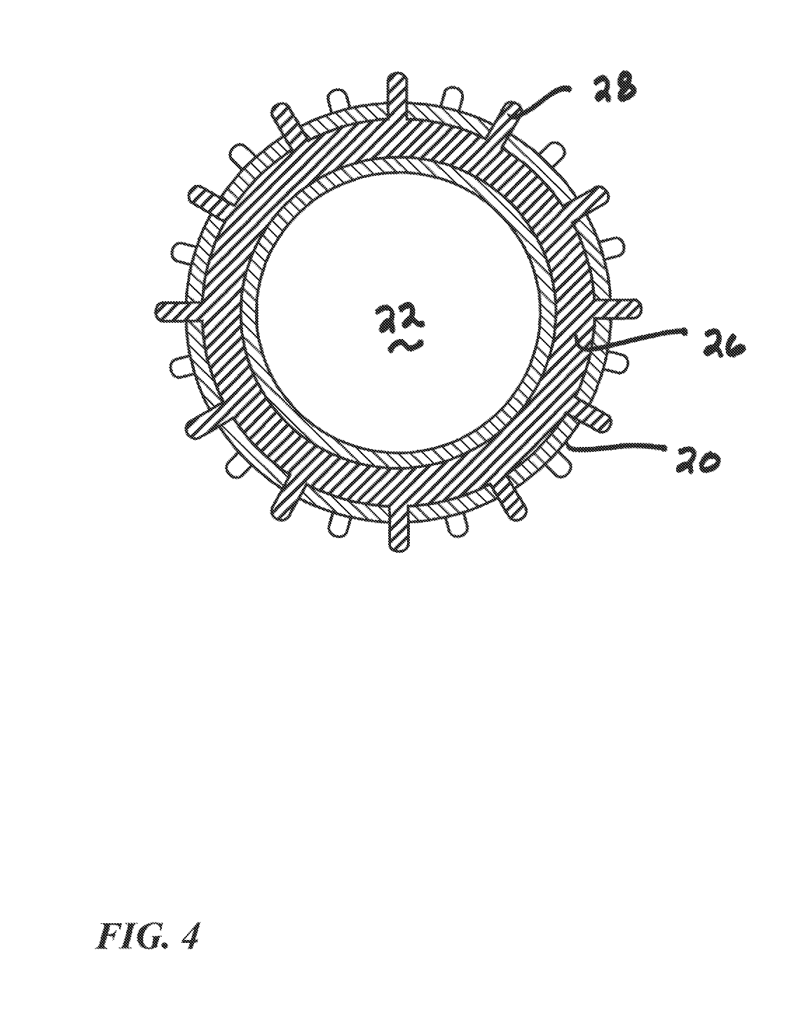

In the embodiment shown in FIGS. 1-5, body 12 of the device is made of a first low durometer material and structural ring 26 is made of a second low durometer material that is firmer or has a higher durometer than the first low durometer material. In this manner structural ring 26 provides structural support to enable the device to maintain its general shape, particularly in the sidewall 20, so that the sidewall can be inserted into the fornices without collapsing upon contact with the vaginal wall or cervix as the user is trying to manipulate the device into position. The slightly harder durometer material of the projections 28 also creates a stimulating effect on the upper walls of the vagina when sidewall 20 is in position within the fornices, particularly upon movement of the device due to pressure from the penis contacting the caudal end of the device or movement caused by the stimulation ring 32 (FIG. 3b). The slightly harder durometer material is also useful for the handle 30 in order to be able to pull the device out of the vagina with the handle.

In addition to the embodiment shown in FIGS. 1-5, it is noted that the structural ring may not include projections 28 and/or handle 30, but may instead simply serve as an integral embedded support structure for the device. In addition, while the projections 28 extend from structural ring 26 in the embodiment shown, it is anticipated that projections could alternatively be integrally formed with the outer surface of body 12. In addition, the outer surface of body 12 could alternatively have any number of different surface variations including bumps, waves, detents, and the like to stimulate the vaginal walls and increase the overall surface area of the device in contact with the vaginal walls. Lastly, an alternative embodiment is anticipated where body 12 is made from different durometer materials. Specifically, base 18 may be made from a first low durometer material and sidewall 20 may be made from a second low durometer material that is firmer or has a higher durometer than the first low durometer material. In this alternative embodiment, the structural ring can be omitted provided the sidewall has sufficient rigidity to enable it to be guided into position within the fornices.

As indicated above, device 10 is made from a soft low durometer resilient material, such as a soft rubber, plastic and/or elastomer. In addition, a liquid, gel, foam, gas or sponge material may be included within portions of the device to enhance the feel of the device to the user. The low durometer material preferably has a durometer of Shore 000, 00, 0 and/or A as measured by ASTM D2240. In the embodiment shown in FIGS. 1-5, the durometer of the first durometer material used to form base 18 preferably ranges to 5 to 50 Shore 00, most preferably about 10 Shore 00. The durometer of the second durometer material used to form structural ring 26 preferably ranges from 50 Shore 00 to 20 Shore A, preferably about 5 Shore A.

The low durometer material may comprise any low durometer material having elasticity that is non-toxic and stable. The material preferably can be sterilized using known methods such as via steam or ethylene oxide. Preferred materials include silicone based materials such as medical grade liquid silicone rubber (dimethyl silicone elastomer) that can be molded and cured to form a device with minimal surface tack. The device is preferably formed by casting or molding, whereby elongated structural ring 26 is pre-formed from the second durometer material and then positioned within a mold in which the first durometer material is molded around the structural ring to form the final device. In a preferred embodiment, the final device is formed via injection molding.

The overall size and shape of the device may vary to fit the anatomy of the user. In one embodiment, it is anticipated that the device will be produced in a series of different dimensions, varying in the overall length of device 10, the length and width of sidewall 20, the width and depth of cavity 22, and optionally, the width and depth of detent 24. A physician or other healthcare provider will measure the vaginal length, cervical diameter and fornical length of the user. The device dimensioned to best correspond with these measurements will then be determined for the user. In an alternative embodiment, the measurements taken of the user could be used to manufacture a custom fit device or alternatively a mold of the user's upper vaginal region or entire vagina could be made as is known in the art and used to manufacture a custom fit device for the user. A measurement of the male partner's erect penis may also be used in determining the best overall length of device 10 and width and depth of detent 24, or, in the alternative embodiment, be used in manufacturing a custom fit device.

In general, it is anticipated that the overall length of the device may range from about 0.5 to 6 inches, preferably about 1 to 4 inches, and most preferably about 1.75 to 2.25 inches. The length of the device best suited to a user will depend upon the length of the vagina, the length of the fornices, and the length of the male partner's penis. The length of sidewall 20 (and correspondingly the depth of recess 22) may range from about 33% to about 66% of the overall length of the device and preferably is about 50% of the overall length of the device. The length of the sidewall may range from about 0.25 to 3 inches, preferably about 0.5 to 2 inches, and most preferably about 0.75 to 1.5 inches. The length of the sidewall best suited to a user will depend on the fornical length. The outer diameter of sidewall 20 (and correspondingly of device 10) will preferably range from about equal the length of sidewall 20 to about twice the length of sidewall 20. The outer diameter of sidewall 20 may range from about 1.5 to 3.5 inches, preferably about 1.75 to 2.75 inches, and most preferably about 2 inches. The outer diameter of sidewall 20 best suited to a user will depend on the fornical and cervical width of the user. The inner diameter of sidewall 20 defining cavity 22 may range from about 50% to 80%, preferably about 60% to 70% of the outer diameter of the sidewall. The inner diameter of sidewall 20 may range from about 1 to 2.25 inches, preferably about 1.25 to 2 inches. The inner diameter of sidewall 20 best suited to a user will depend on the cervical width of the user.

In the embodiment shown in FIGS. 1-5, the outer diameter of the device is uniform from the cephalad end to the caudal end. However, it is anticipated that base 18 may have a different outer diameter than sidewall 20. The outer diameter of sidewall 20 is dependent on the fornical and cervical width and is configured to enable the sidewall to fit within the fornices. Base 18 is not intended to fit within the fornices and may therefore be wider or narrower depending on a number of factors including the softness and distensibility of the base, the length of the base, the length and girth of the male partner's penis, and/or the overall width of the user's vagina. Furthermore, the base may be tapered inwardly or outwardly toward the caudal end.

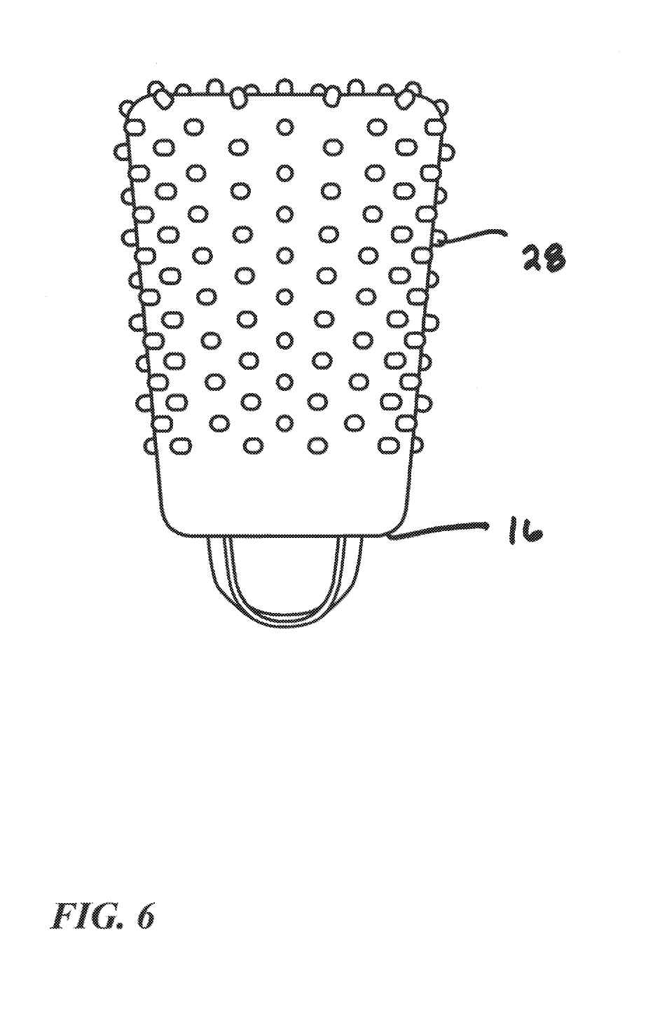

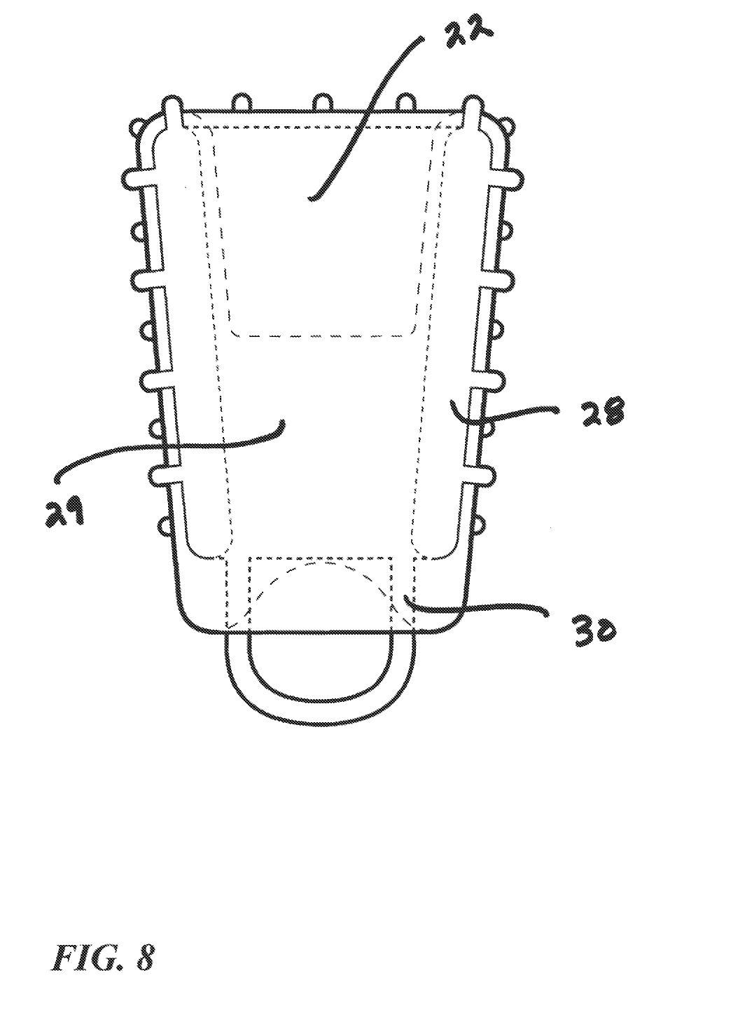

For example, as shown in FIGS. 6-8, the device may be tapered inwardly toward the caudal end. The structural ring 26 is angled inwardly toward the caudal end and includes projections 28 extending outwardly from the exterior of the sidewall 20 and base 18. Looking to FIG. 8, the handle 30 is integrally formed with structural ring 26 whereby a flat sheet 29 extends from one side of the ring to the other below the recess 22 with the handle formed in the bottom of the sheet.

The maximum depth of detent 24 will typically range from about 12.5% to 50%, preferably 25% to 40% of the length of base 18. The maximum depth of the detent will typically range from about 0.125 to 1.5 inches, preferably 0.25 to 0.75 inches, most preferably about 0.5 inches. The maximum width of detent will typically range from about 40% to 80%, preferably 50% to 75% of the width of base 18 (i.e. the outer diameter of the device at the caudal end). The maximum width of the detent will typically range from about 0.5 to 2.5 inches, preferably about 0.75 to 1.75 inches. The maximum depth and width of the detent best suited to a user will depend on the softness and distensibility of the base, the length of the base, the length and girth of the male partner's penis, and/or the overall width of the user's vagina.

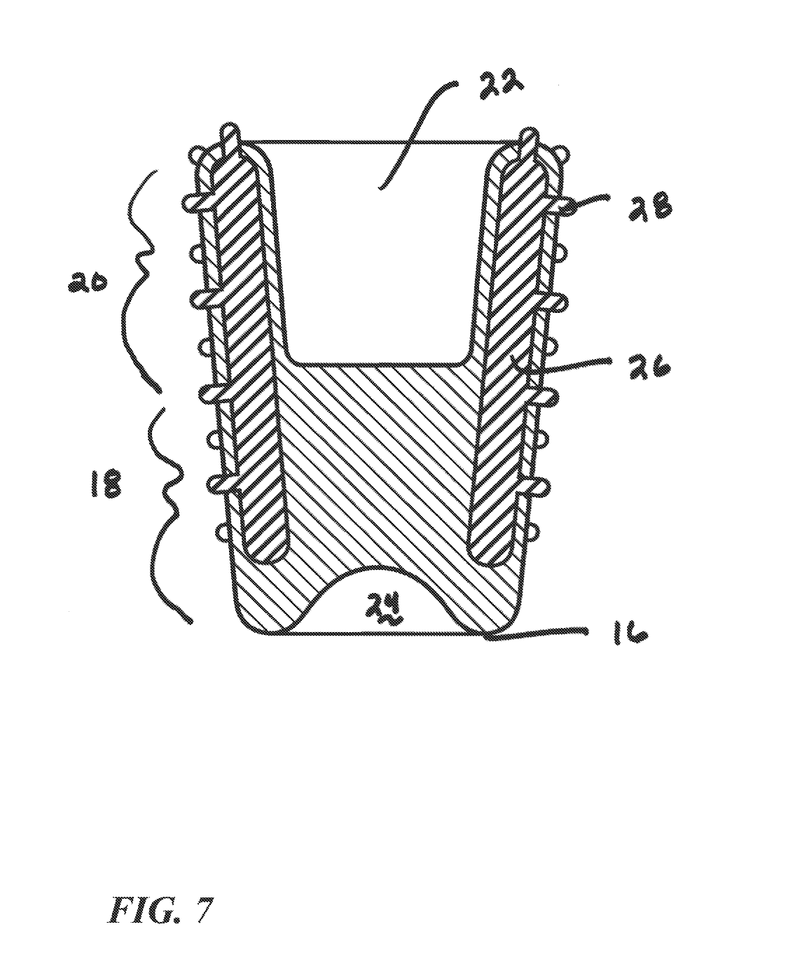

Looking to FIGS. 3a, 3b and 7 structural ring 26 has a top positioned a distance below the top of sidewall 20, an outer diameter that is about 90% to 95% of the outer diameter of sidewall 20, and an inner diameter that is about 110% to 120% of the inner diameter of sidewall 20. In this manner, the main body of structural ring 26 (not including projections 28 and handle 30) is embedded within the sidewall a distance such that a certain amount of deflection of the outer sidewall can occur upon contact before deflection of structural ring 26. In the embodiments shown in FIGS. 3a and 7, structural ring 26 extends downwardly into a portion of base 18, preferably extending into base from about 25% of the length of base 18 to the entire length of the device. In the alternative embodiment shown in FIG. 3b, structural ring 26 only extends within sidewall 20.

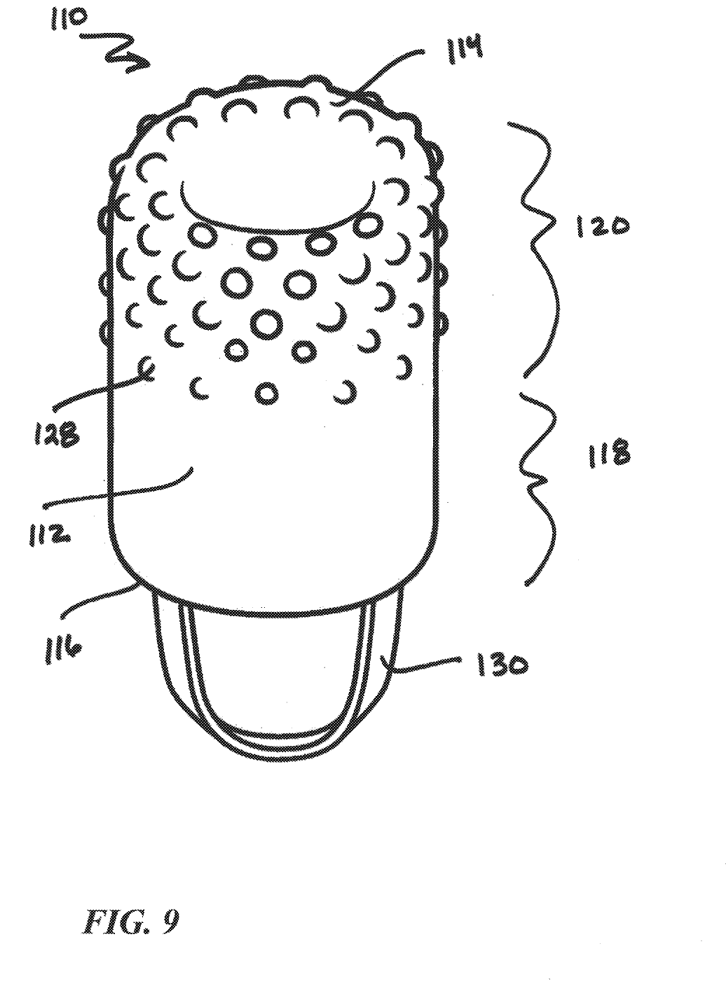

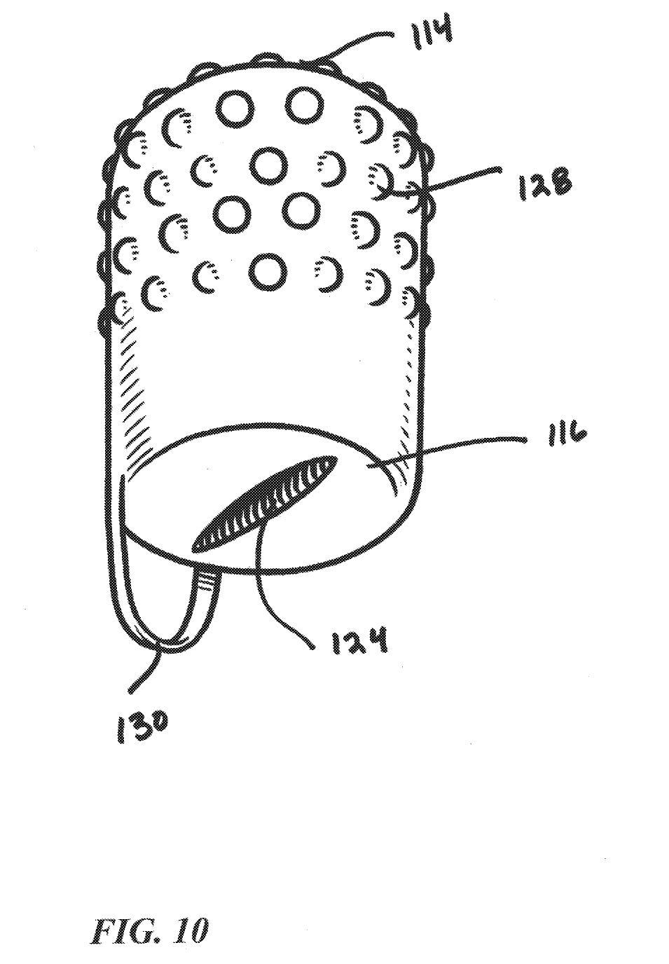

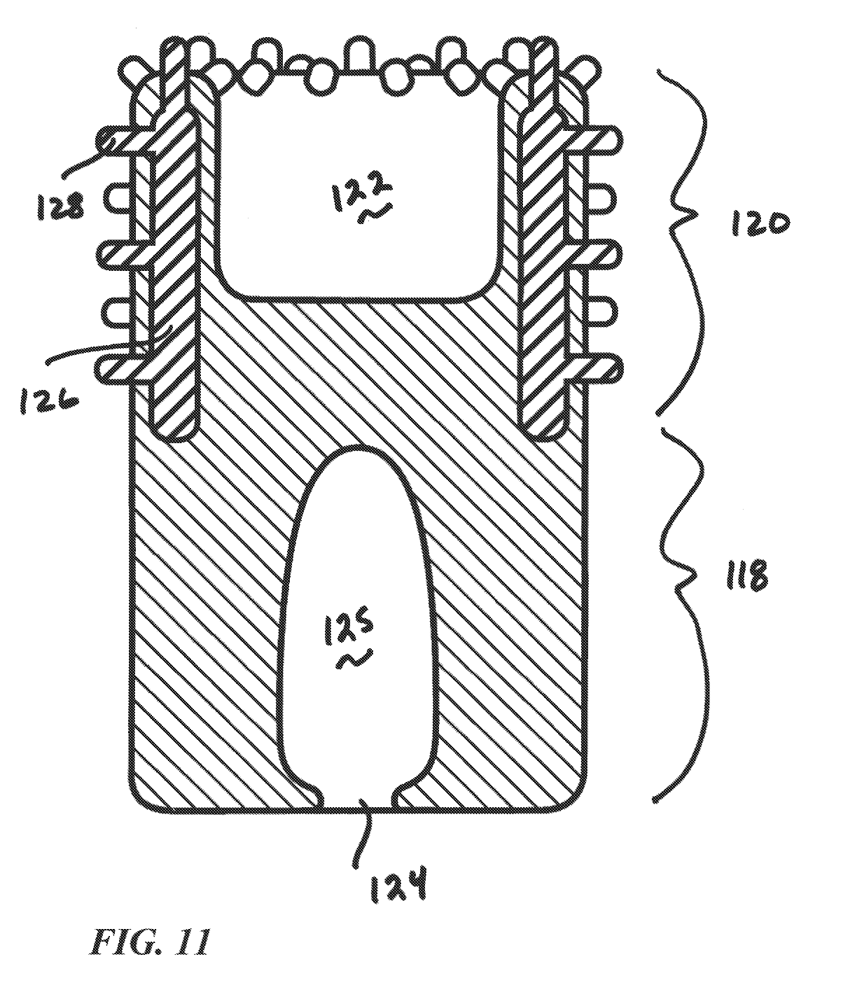

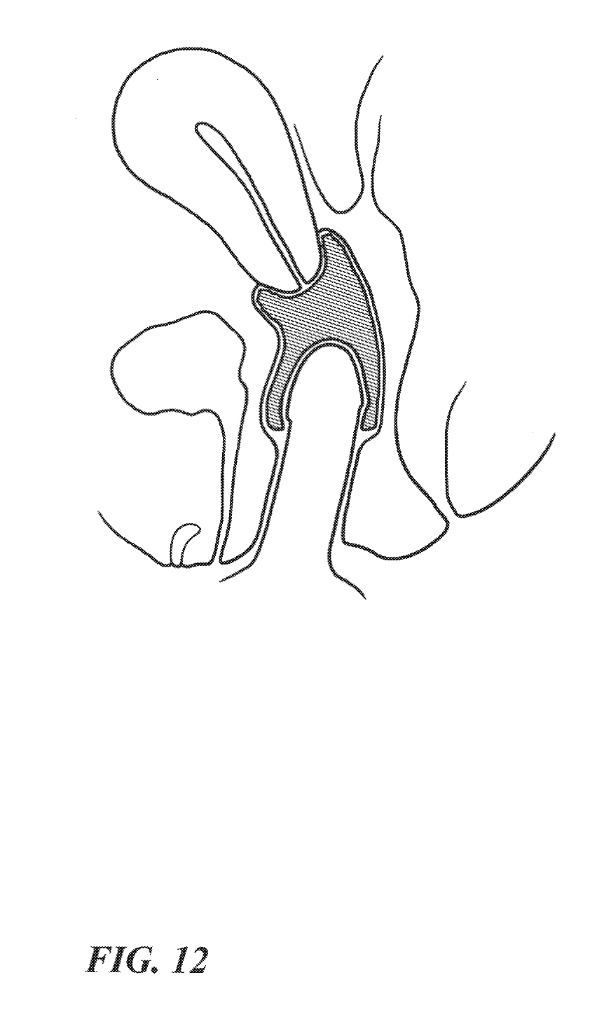

A device in accordance with a second embodiment of the present invention is generally designated in FIG. 9 by the numeral 110. Device 110 is configured similarly to device 10 of the first embodiment shown in FIGS. 1-5 having a cylindrical body 112 extending from an upper cephalad end 114 to a lower caudal end 116. However, in this embodiment, as best shown in FIGS. 10 and 11, lower caudal end 116 includes a central narrow slot 124 that accesses an oval-shaped cavity 125 within body 112. (FIG. 11). Slot 124 and cavity 125 are configured to receive the distal end or glans of the penis. Slot is relatively narrow providing the feeling of a tight opening of the vagina. Sidewall 120, recess 122, structural ring 126, projections 128 and handle 130 all are as heretofore discussed with respect to the first embodiment

In this embodiment, it is anticipated that the overall length of the device will be longer ranging from about 2 to 6 inches, preferably about 2.5 to 5 inches, and most preferably about 3 to 4 inches. The length of the device best suited to a user will depend upon the length of the vagina, the length of the fornices, and the length of the male partner's penis. The length of sidewall 120 (and correspondingly the depth of recess 122) may range from about 20% to about 50% of the overall length of the device and preferably is about 30% of the overall length of the device. The length of the sidewall may range from about 0.25 to 3 inches, preferably about 0.5 to 2 inches, and most preferably about 0.75 to 1.5 inches. The length of the sidewall best suited to a user will depend on the fornical length. The outer and inner diameters of sidewall 120 (and correspondingly of device 110) will be as stated with regard to the first embodiment.

In the embodiment shown in FIGS. 9-11, the outer diameter of the device is uniform from the cephalad end to the caudal end. However, it is anticipated that base 118 may have a different outer diameter than sidewall 120. The outer diameter of sidewall 120 is dependent on the fornical and cervical width and is configured to enable the sidewall to fit within the fornices. Base 118 is not intended to fit within the fornices and may therefore be wider or narrower depending on a number of factors including the softness and distensibility of the base, the length of the base, the length and girth of the male partner's penis, and/or the overall width of the user's vagina. The base may also be tapered inwardly or outwardly toward the caudal end such as shown in FIGS. 6-9. The maximum depth of cavity 125 will typically range from about 1 to 9 inches, preferably 2 to 4 inches, most preferably about 2 to 3 inches. The maximum width of the cavity will typically range from about 1 to 3 inches, preferably about 1 to 2 inches. The maximum depth and width of cavity 125 best suited to a user will depend on the softness and distensibility of the base, the length of the base, the length and girth of the male partner's penis, and/or the length of the user's vagina.

Structural ring 126 has a top positioned a distance below the top of sidewall 120, an outer diameter that is about 90% to 95% of the outer diameter of sidewall 120, and an inner diameter that is about 110% to 120% of the inner diameter of sidewall 120. Structural ring 126 extends downwardly into an upper portion of base 118 such that the bottom of structural ring is positioned level with or above the upper end or tip of cavity 125. In an alternative embodiment, structural ring 126 may extend only within sidewall 120 or may extend further into the base toward the caudal end. The structural ring may also comprise a spring or other resilient device that enables a portion of the body to be compressed and extended.

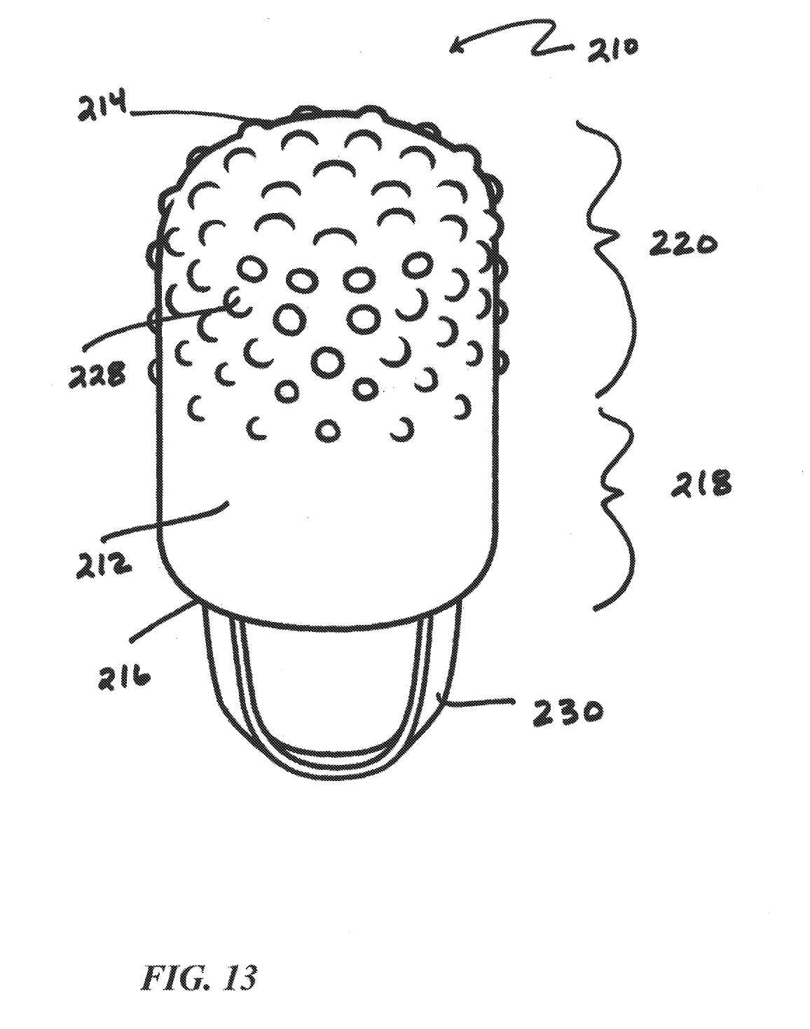

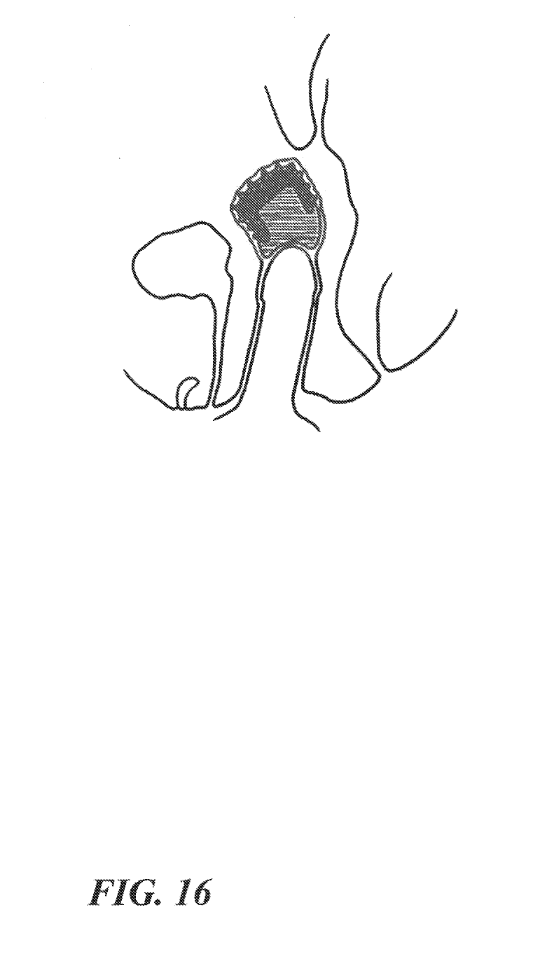

A device in accordance with another embodiment of the present invention is generally designated in FIG. 13 by the numeral 210. Device 210 is configured for use during sexual intercourse by a female user that has had her cervix removed via hysterectomy. Device 210 is similar to device 10 of the first embodiment having a cylindrical body 212 extending from an upper cephalad end 214 to a lower caudal end 216, except that body 212 has a closed generally cap-shaped top with no recess. While end 214 is shown with a generally flat top, it is anticipated that the top may have a convex dome shape. Body 212 includes a cylindrical smooth lower section 218 extending from lower end 216 to about a mid-point of device 210, and an upper textured section 220 extending upwardly from lower section 218 to upper end 214. Upper section 220 is configured to generally correspond in shape with the uppermost part of the vagina where the fornices and cervix of the user were positioned prior to the hysterectomy such that the upper section may be inserted into the uppermost part of the vagina. In this manner, the top and outer surface of upper section 220 is positioned in abutting contact with corresponding top and upper side vaginal walls of the upper vagina (FIG. 16).

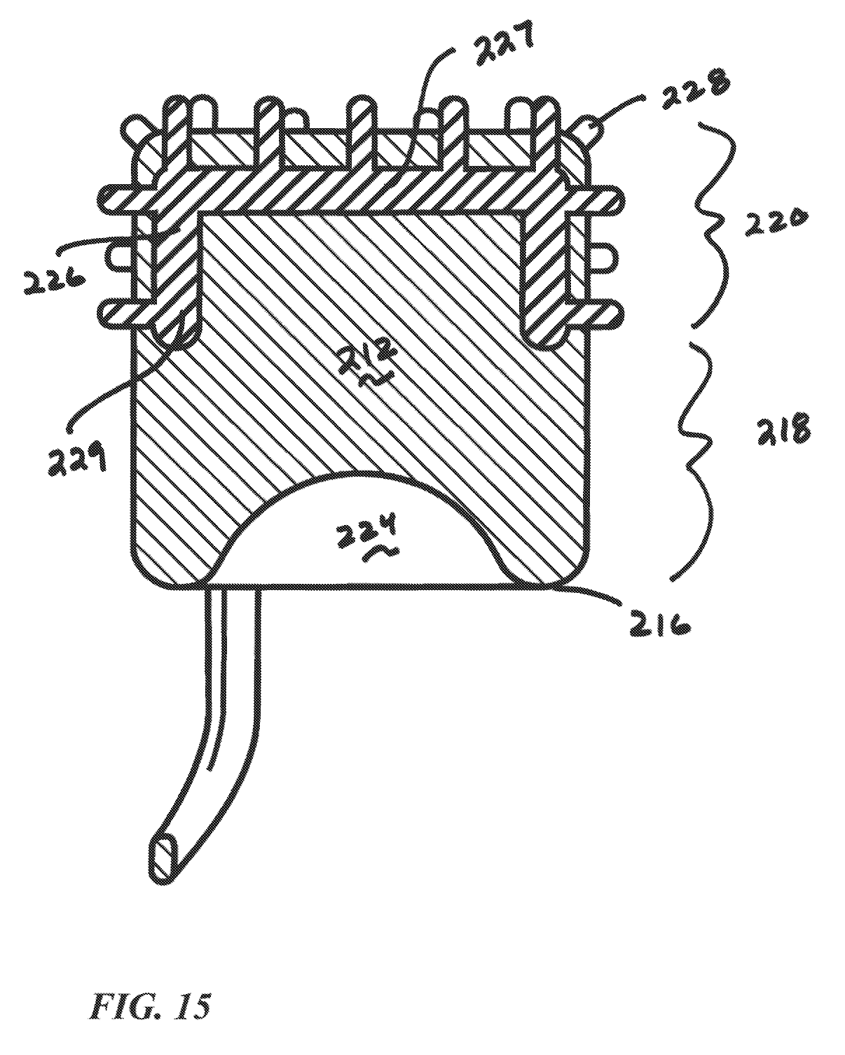

Looking to FIG. 15, lower caudal end 216 includes a central detent 224 configured as described in relation to the first embodiment. While the particular embodiment shown includes detent 224, it is anticipated that the caudal end may alternatively be generally flat or may include a narrower slot and cavity to receive the penis as disclosed in relation to the second embodiment. Structural c-shaped plate 226 is embedded within body 212. Structural plate 226 has a circular top plate 227 with a flange 229 extending downwardly from the outer periphery of the plate. Top plate 227 is positioned a distance below the top of upper section 220 and flange 229 has an outer diameter that is about 90% to 95% of the outer diameter of upper section 220.

Projections 228 extend outwardly from top plate 227 and flange 229 through the outer side and top surface of upper section 220. Handle 230 extends outwardly through the outer surface of body 212. Projections 228 are configured to stimulate the top and side vaginal walls of the upper vagina. While the projections are depicted only along the outer side and top surface of the side wall, it is noted that projections could extend along the entire length of the device and/or extend from the caudal end of the device. Handle 230 is configured to enable the user to grasp the handle with one or more fingers and remove the device when not in use.

While not shown in relation to this embodiment, it is anticipated that a stimulation ring similar to that described with regard to the embodiment shown in FIG. 3b may be embedded within lower section 218 below structural plate 226. In an alternate embodiment, a mechanism may be incorporated within structural plate 226 for moving, heating and/or cooling structural plate 226.

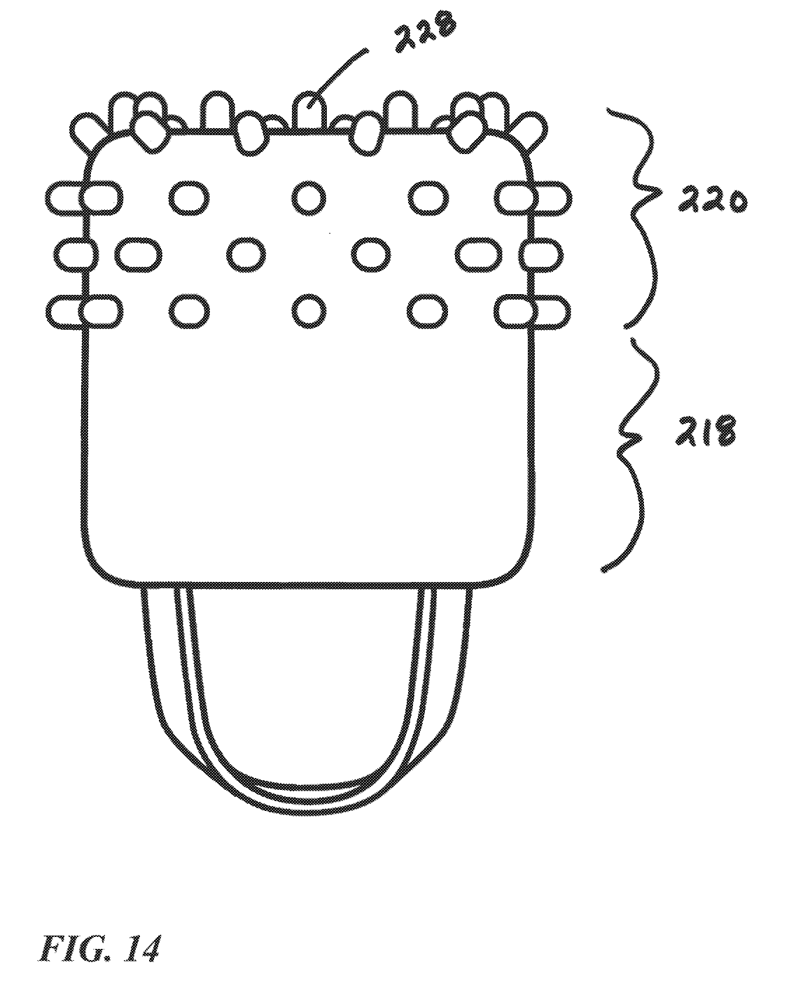

In the embodiment shown in FIGS. 13-16, body 212 of the device is made of a first low durometer material and structural plate 226 is made of a second low durometer material that is firmer or has a higher durometer than the first low durometer material. In this manner structural plate 226 provides structural support to enable the device to maintain its general shape, particularly in the upper section 220, so that the upper section 220 can be easily inserted into the upper vagina to hug the upper vaginal walls and provide stimulating contact therewith. The slightly harder durometer material of the projections 228 also creates a stimulating effect on the walls of the vagina, particularly upon movement of the device due to pressure from the penis contacting the caudal end of the device (or additionally movement caused by a mechanism in structural plate 226 or a stimulation ring). The slightly harder durometer material is also useful for the handle in order to be able to pull the device out of the vagina with the handle.

In addition to the embodiment shown in FIGS. 13-15, it is noted that the structural plate may not include projections 228 and/or handle 230, but may instead simply serve as an integral embedded support structure for the device. In addition, while the projections 228 extend from structural plate 226, it is anticipated that projections could alternatively be integrally formed with the outer surface of upper section 220. In addition, the outer surface of upper section 220 or of the entire device could alternatively have any number of different surface variations including bumps, waves, detents, and the like to stimulate the vaginal walls and enhance the overall surface area of the device in contact with the vaginal walls. Lastly, an alternative embodiment is anticipated where body 212 is made from different durometer materials. Specifically, lower section 218 may be made from a first low durometer material and upper section 220 may be made from a second low durometer material that is firmer or has a higher durometer than the first low durometer material. In this alternative embodiment, the structural plate can be omitted provided the upper section has sufficient rigidity to enable it to be positioned within the upper vagina. The materials used for this embodiment are as described in relation to the first embodiment.

The overall size and shape of the device may vary to fit the anatomy of the user as previously described. In one embodiment, it is anticipated that the device will be produced in a series of different dimensions, varying in the overall length of device 210, the length and width of upper section 220, and the width and depth of detent 224. A physician or other healthcare provider will measure the vaginal length, and the length of the upper most vaginal region where the cervix and fornices were positioned prior to the hysterectomy. The device dimensioned to best correspond with these measurements will then be determined for the user.

In general, it is anticipated that the overall length of the device may range from about 0.5 to 6 inches, preferably about 1 to 4 inches, and most preferably about 1.75 to 2.25 inches. The length of the device best suited to a user will depend upon the length of the vagina, the length of the upper vagina, and the length of the male partner's penis. The length of upper section 220 may range from about 33% to about 66% of the overall length of the device and preferably is about 50% of the overall length of the device. The length of upper section 220 may range from about 0.25 to 3 inches, preferably about 0.5 to 2 inches, and most preferably about 0.75 to 1.5 inches. The length of upper section best suited to a user will depend on the length of the upper vagina. The outer diameter of upper section 220 (and correspondingly of device 210) will preferably range from about equal the length of upper section 220 to about twice the length of upper section 220. The outer diameter of upper section 220 may range from about 1.5 to 3.5 inches, preferably about 1.75 to 2.75 inches, and most preferably about 2 inches. The outer diameter of upper section 220 best suited to a user will depend on the width of the upper vagina of the user.

In the embodiment shown in FIGS. 13-15, the outer diameter of the device is uniform from the cephalad end to the caudal end. However, it is anticipated that lower section 218 may have a different outer diameter than upper section 220 and may be tapered inwardly or outwardly toward the caudal end. The outer diameter of upper section 220 is dependent on the width of the upper vagina and is configured to enable the upper section to fit within the upper vagina. Lower section 218 is not intended to fit within the upper vagina and may therefore be wider or narrower depending on a number of factors including the softness and dispensability of the lower section, the length of the lower section, the length and girth of the male partner's penis, and/or the overall width of the user's vagina.

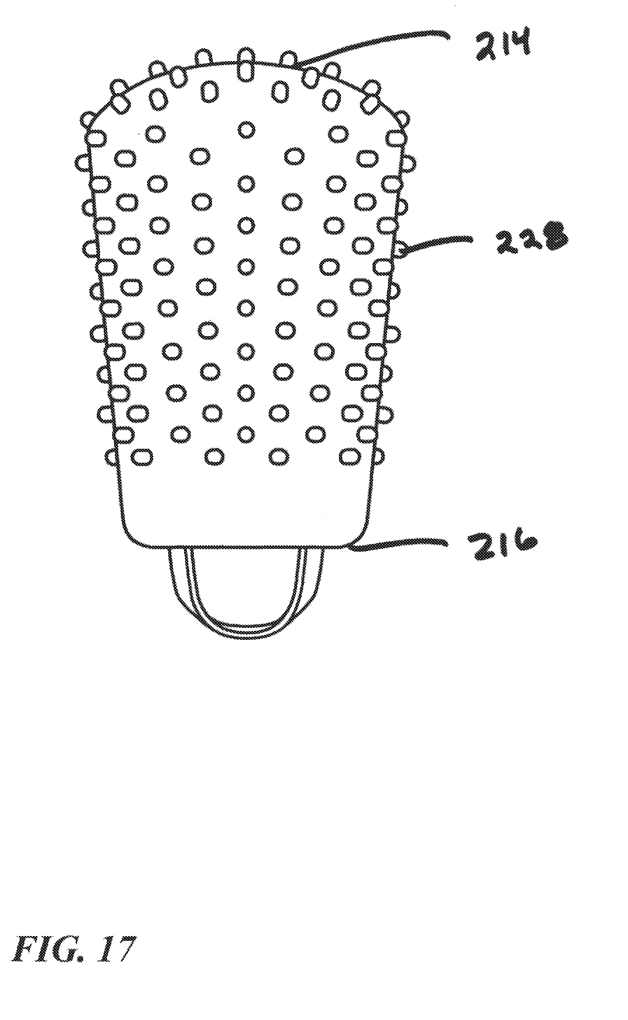

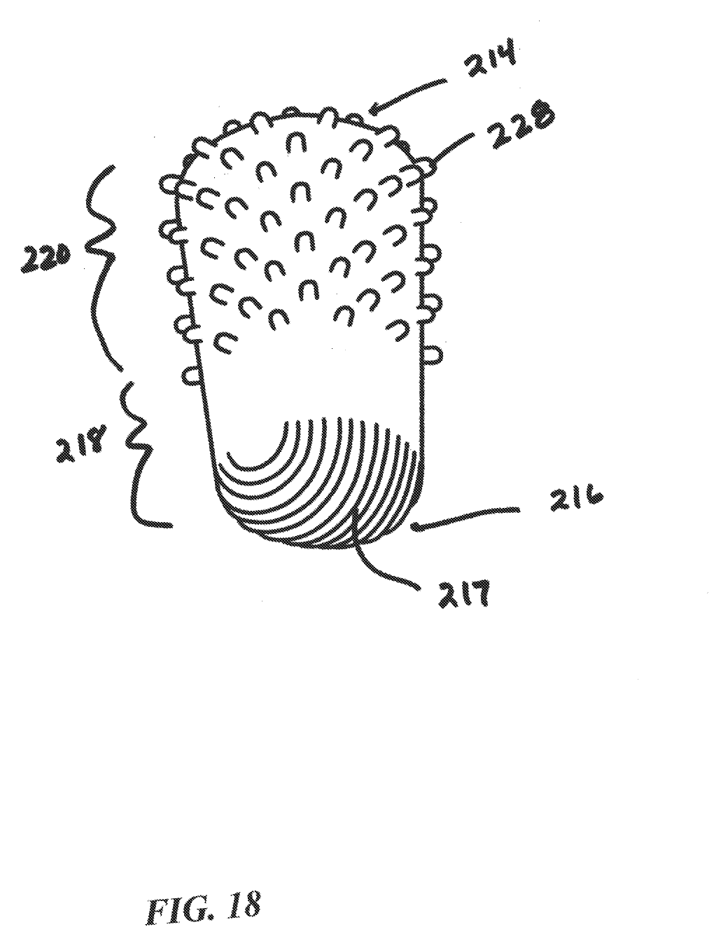

For example, in the alternative embodiments shown in FIGS. 17 and 18, body 212 is tapered inwardly toward the caudal end 216. In addition, in the embodiment shown in FIG. 18, the lower portion of base 218 has been cut to form fringe-like slivers 217 of the material making up the lower portion of the base. These slivers 217 enable the end of the penis to be inserted between adjacent slivers and for the individual slivers to move independently in response to contact and pressure from the penis.

Looking again to FIG. 15, the maximum depth of detent 224 will typically range from about 12.5% to 50%, preferably 25% to 40% of the length of lower section 218. The maximum depth of the detent will typically range from about 0.125 to 1.5 inches, preferably 0.25 to 0.75 inches, most preferably about 0.5 inches. The maximum width of detent will typically range from about 40% to 80%, preferably 50% to 75% of the width of lower section 218 (i.e. the outer diameter of the device at the caudal end). The maximum width of the detent will typically range from about 0.5 to 2.5 inches, preferably about 0.75 to 1.75 inches. The maximum depth and width of the detent best suited to a user will depend on the softness and distensibility of the lower section, the length of the lower section, the length and girth of the male partner's penis, and/or the overall width of the user's vagina.

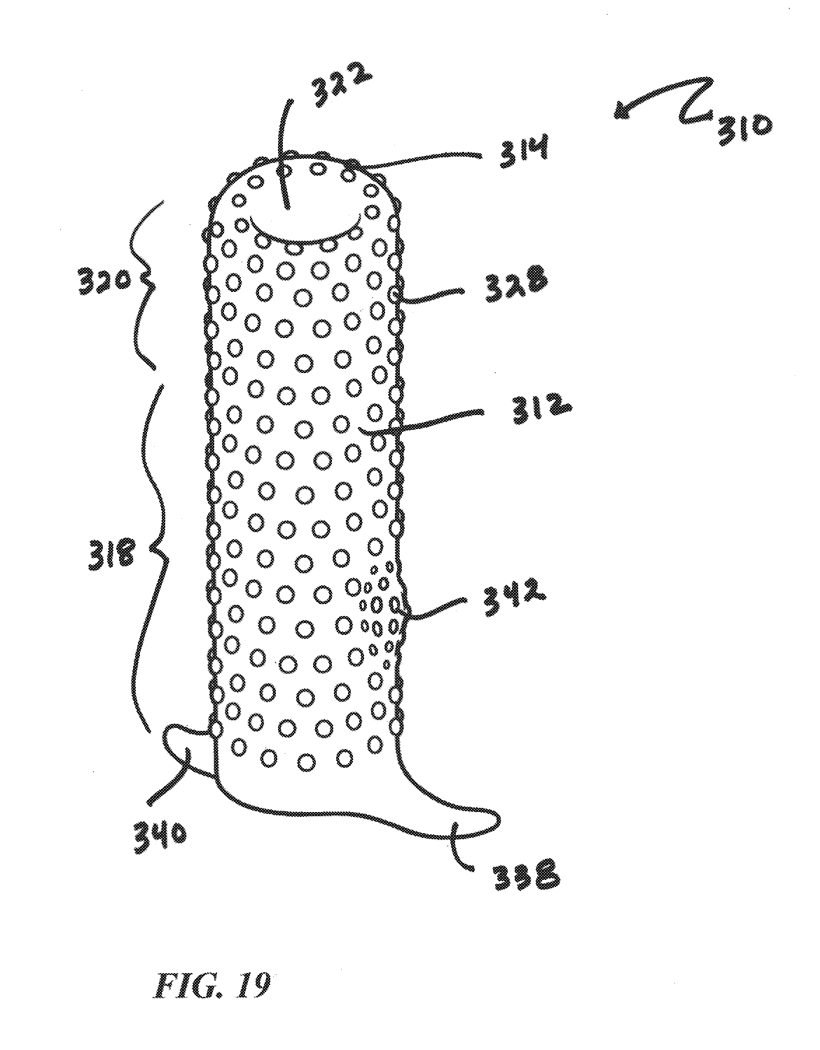

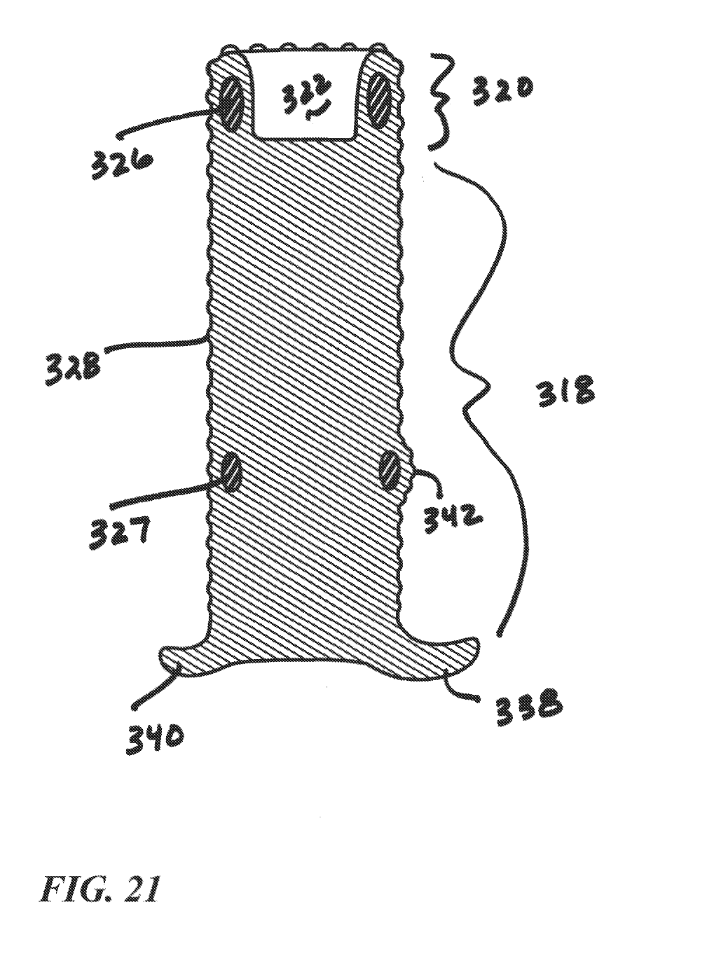

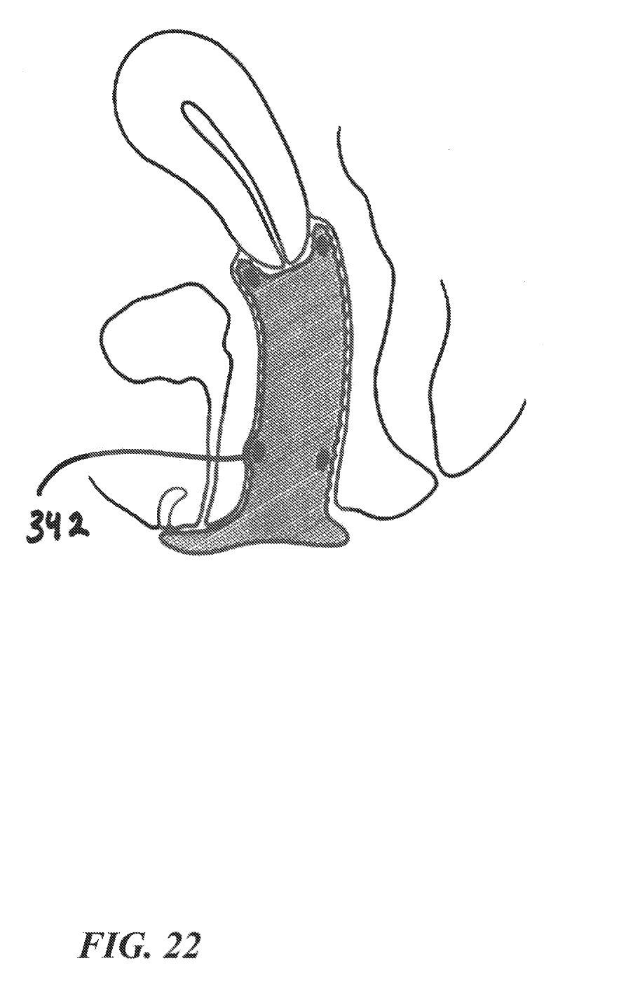

A device in accordance with another embodiment of the present invention is generally designated in FIG. 19 by the numeral 310. Device 310 is configured for self-stimulation by a female user that has a cervix. Device 310 has an elongated cylindrical body 312 extending from an upper cephalad end 314 to a lower caudal end 316. Looking to FIG. 21, body 312 has an elongated base 318 extending from lower end 216 to an upper portion of device 310, and a ring-shaped sidewall 320 extending upwardly from the outer periphery of base 318 to upper end 314. Ring-shaped sidewall 320 defines a well-shaped recess 322 accessible through upper end 314. Ring-shaped sidewall 320 is configured to generally correspond in shape with the fornices of the user such that sidewall 320 can be inserted into the fornices of the user with the cervix received within recess 322. In this manner, the top and outer surface of sidewall 320 is positioned in abutting contact with corresponding top and side vaginal walls of the fornices (FIG. 22).

Looking to FIG. 21, lower caudal end 316 includes a tail-shaped flanges 338, 340 extending from the front and rear of caudal end 316 respectively. Flanges 338, 340 serve as a handle for the user to grasp and manipulate the device. Flange 338 is configured to extend from the anterior fourshette to the clitoris such that the tip of the flange rests in abutting engagement or contact with the clitoris when the device is inserted into the vagina. (FIG. 22). Flange 340 may be configured to extend from the posterior fourshette to the perineum such that the tip of the flange rests in abutting engagement or contact with the perineum when the device is positioned within the vagina. In addition, the front surface of base 318 projects outwardly to form a raised bump 342 positioned in an area corresponding with that of the G-spot when the device is positioned within the vagina. (FIG. 22). Structural rings 326 and 327 are embedded within body 312 adjacent the sidewall 330 and the raised bump 342. Projections 328 extending outwardly from the outer surface of device 310 are configured to stimulate the vaginal walls. It is noted that projections are not included within well-shaped recess 322 in order to avoid irritating the cervix. Recess 322 serves to protect the cervix which can be irritated by contact during sexual intercourse. One or both of the structural rings 326 and 327 embedded within base 318 may include means for enhancing stimulation of the user. These means may include a mechanism for moving the structural ring such as for making the ring vibrate, quiver, or rotate or may include a mechanism for heating the ring. One or both of the structural rings may also comprise a spring or other resilient device that enables a portion of the body to be compressed and extended.

Body 312 is made of a first low durometer material and structural rings 326 and 327 are made of a second low durometer material that is firmer or has a higher durometer than the first low durometer material. In this manner structural rings 326 and 327 provide structural support to enable the device to maintain its general shape, particularly in the sidewall 320, so that the sidewall can be inserted into the fornices without collapsing upon contact with the vaginal wall or cervix as the user is trying to manipulate the device into position.

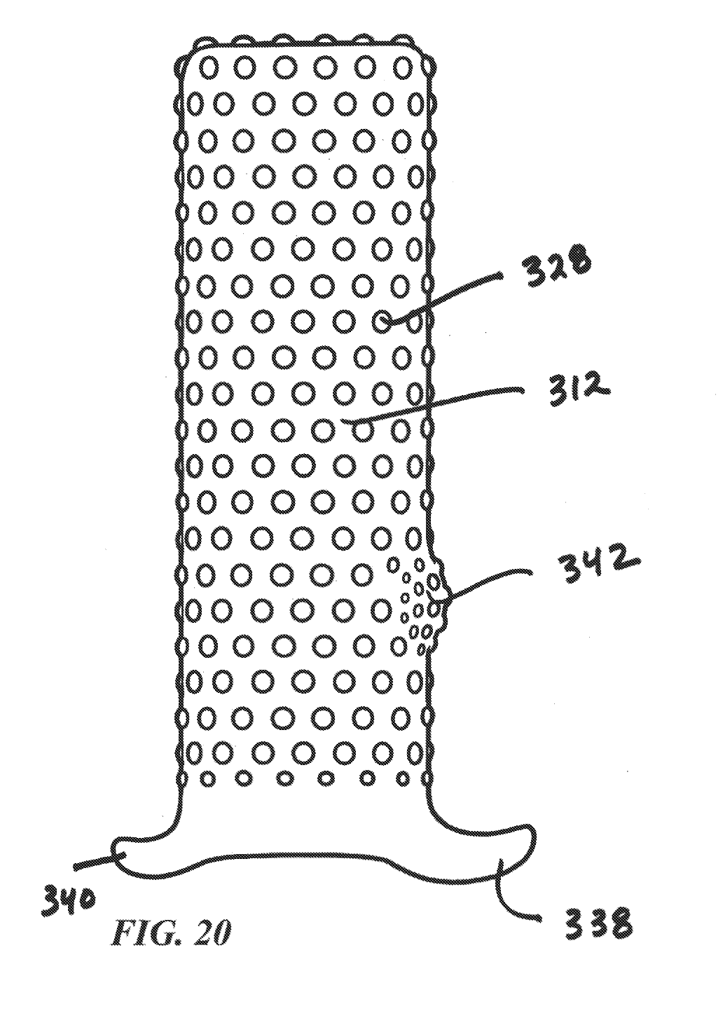

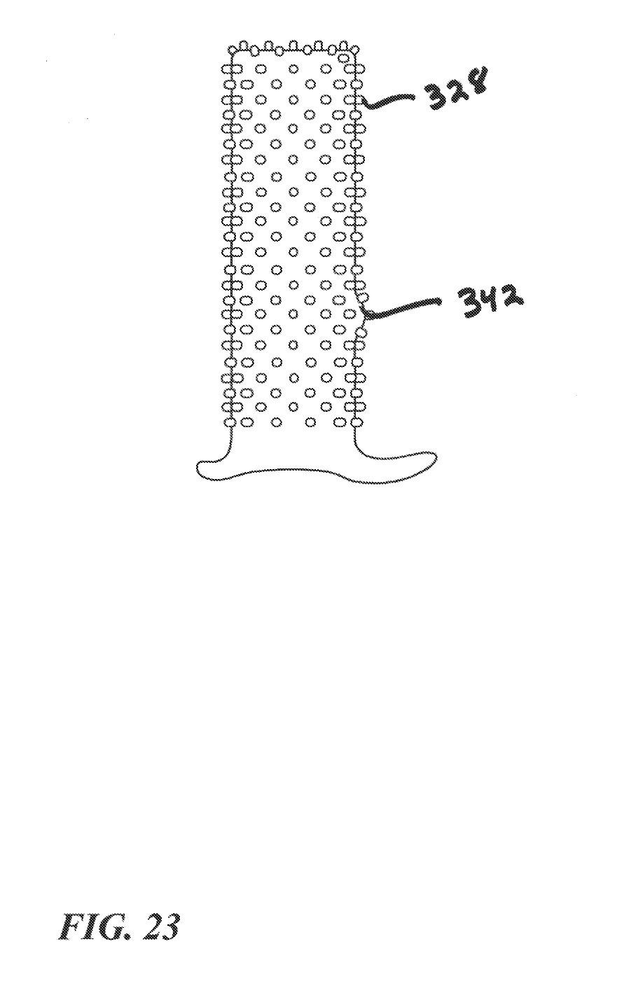

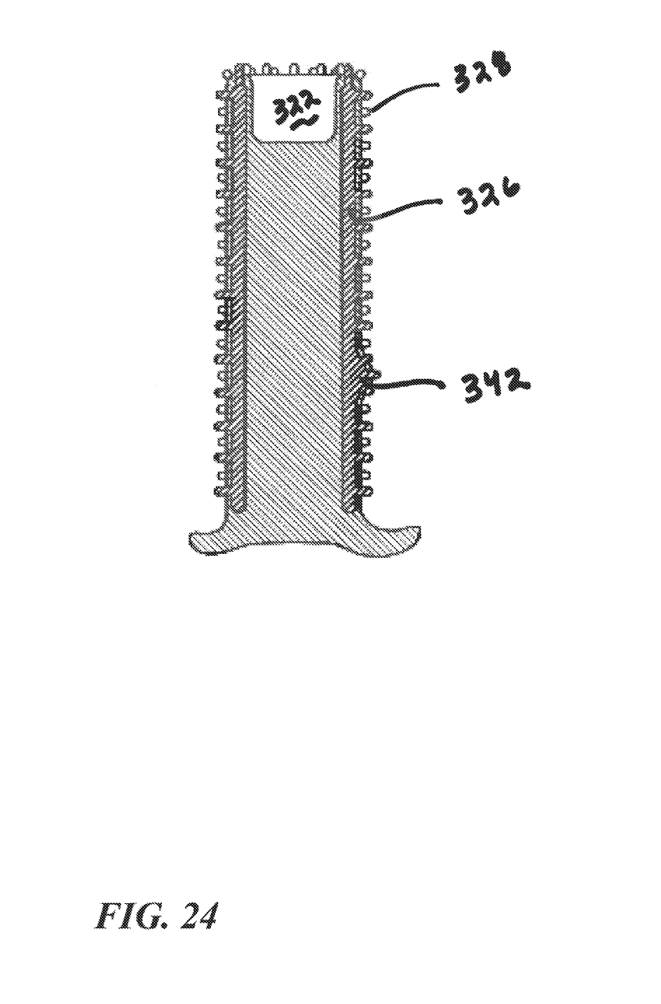

In addition to the embodiment shown in FIGS. 19-22, it is noted that the structural rings may include projections extending outwardly from the ring through the exterior surface of the device similar to the first embodiment as shown in FIGS. 23 and 24. In addition, the outer surface of body 312 could alternatively have any number of different surface variations including bumps, waves, detents, and the like to stimulate the vaginal walls and enhance the overall surface area of the device in contact with the vaginal walls. In addition the body may be tapered inwardly or outwardly toward the caudal end. Lastly, an alternative embodiment is anticipated where body 312 is made from different durometer materials. Specifically, base 318 may be made from a first low durometer material and sidewall 320 may be made from a second low durometer material that is firmer or has a higher durometer than the first low durometer material. In this alternative embodiment, one or both of the structural rings 312 and 313 can be omitted provided sidewall 220 has sufficient rigidity to enable it to be positioned within the fornices. The materials used to make the device are as described in relation to the first embodiment.

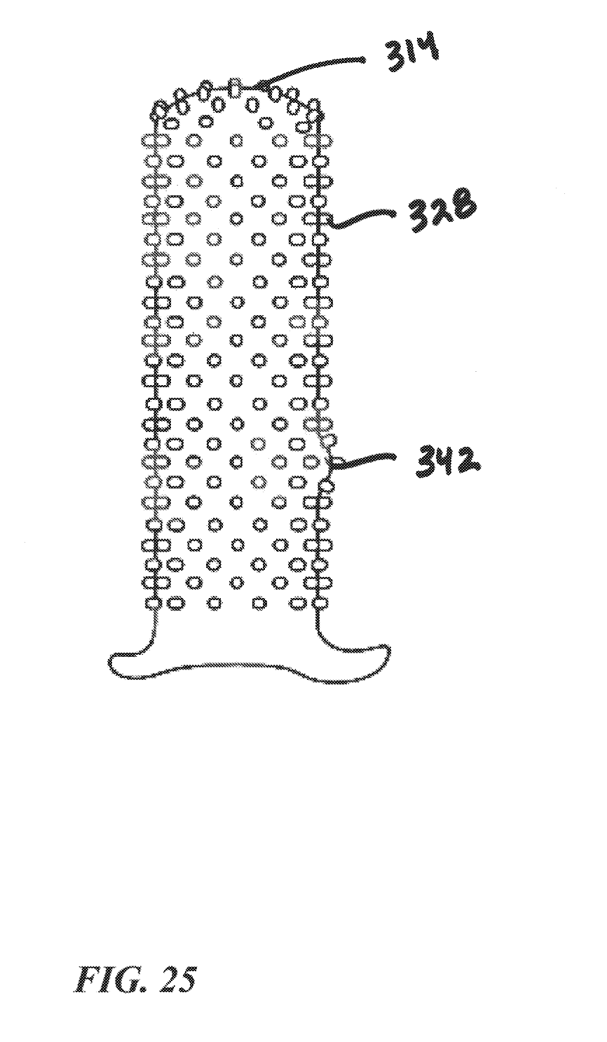

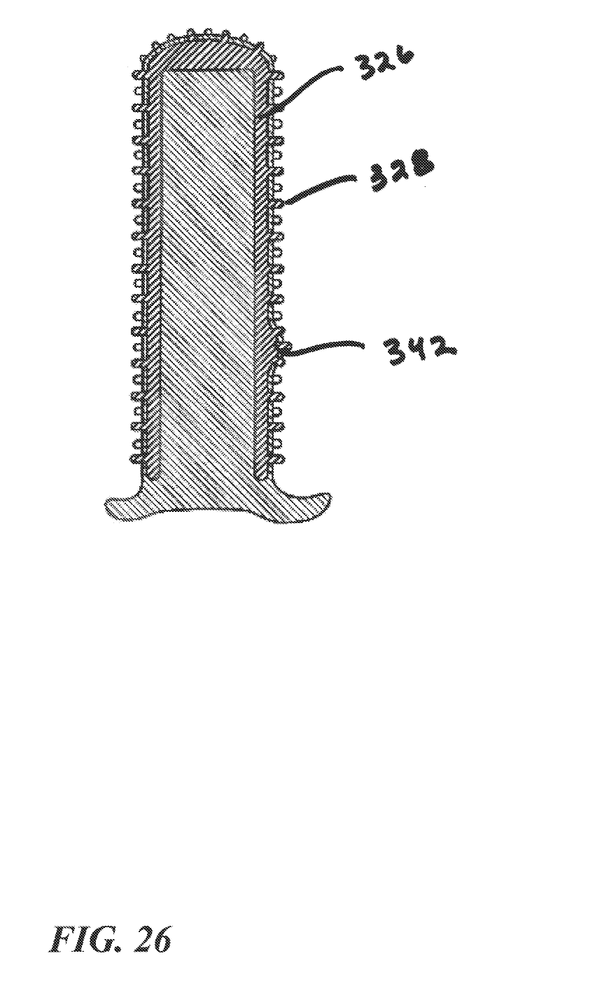

In the embodiment shown in FIGS. 25-26, the cephalad end 314 is solid having a dome-shaped top configured to correspond in shape to the shape of the upper vagina of a female user without a cervix as more fully described in relation to the embodiment shown in FIGS. 13-18. C-shaped plate 326 as described in relation to the embodiment shown in FIG. 15 is embedded within the body to provide support. Projections 328 and bump 342 are integrally formed with c-shaped ring 326.

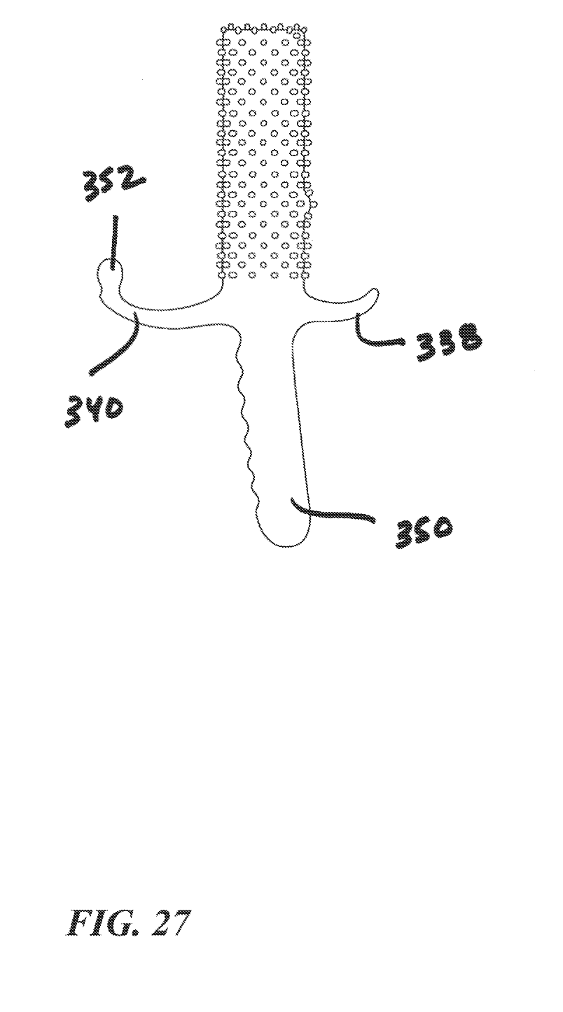

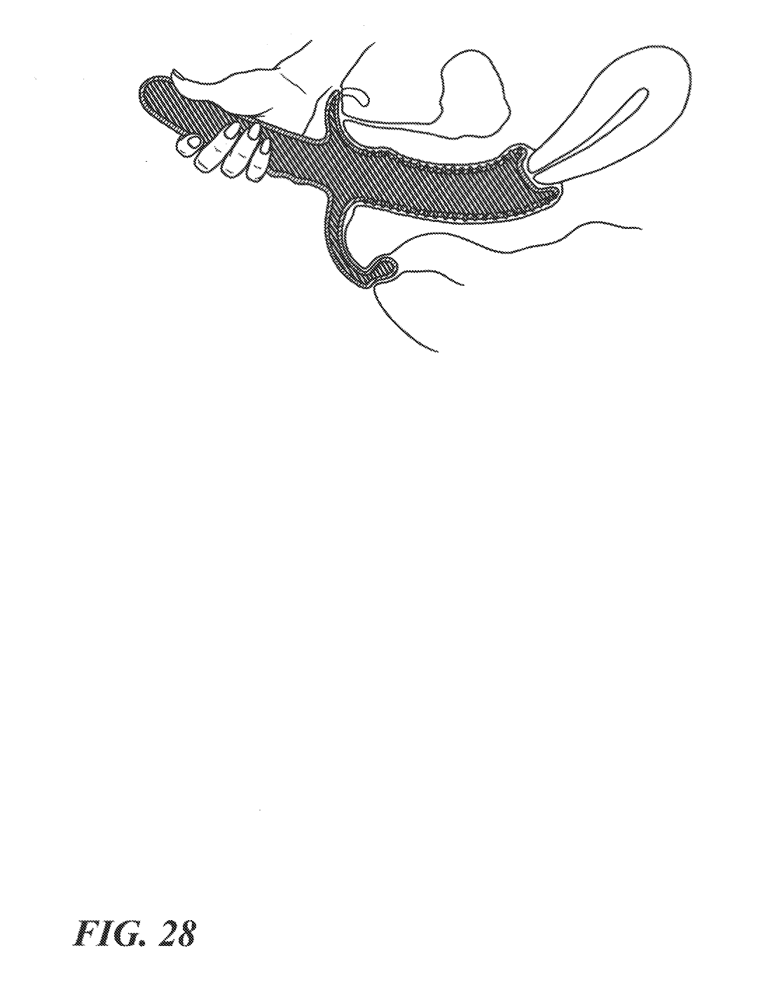

As shown in FIGS. 27-28, the device may include a handle grip 350 for a user to hold and move the device. In addition, a bulbous end 352 may be included on the end of an elongated flange 340 configured to extend into the anus when the device is inserted into the vagina for anal stimulation.

The overall size and shape of the device may vary to fit the anatomy of the user as previously described. In one embodiment, it is anticipated that the device will be produced in a series of different dimensions, varying in the overall length of device 310, the length and width of sidewall 320, the width and depth of cavity 322. A physician or other healthcare provider will measure the vaginal length, cervical diameter and fornical length of the user. The device dimensioned to best correspond with these measurements will then be determined for the user. In an alternative embodiment, the measurements taken of the user could be used to manufacture a custom fit device or alternatively a mold of the user's upper vaginal region or entire vagina could be made as is known in the art and used to manufacture a custom fit device for the user.

In general, it is anticipated that the overall length of the device may range from about 3 to 12 inches, preferably about 6 to 10 inches, and most preferably about 7 to 9 inches. The length of the device best suited to a user will depend upon the length of the vagina. The length of the sidewall may range from about 0.25 to 3 inches, preferably about 0.5 to 2 inches, and most preferably about 0.75 to 1.5 inches. It is preferably about 86% to 12% of the overall length of the device. The length of the sidewall best suited to a user will depend on the fornical length. The outer diameter of sidewall 320 (and correspondingly of device 310) will preferably range from about equal the length of sidewall 320 to about twice the length of sidewall 320. The outer diameter of sidewall 320 may range from about 1.5 to 4 inches, preferably about 1.75 to 2.75 inches, and most preferably about 2 inches. The outer diameter of sidewall 320 best suited to a user will depend on the fornical and cervical width of the user. The inner diameter of sidewall 320 defining cavity 322 may range from about 50% to 80%, preferably about 60% to 70% of the outer diameter of the sidewall. The inner diameter of sidewall 320 may range from about 1 to 2.25 inches, preferably about 1.25 to 2 inches. The inner diameter of sidewall 320 best suited to a user will depend on the cervical width of the user.

In the embodiment shown in FIGS. 19-28, the outer diameter of the device is uniform from the cephalad end to the caudal end. However, it is anticipated that base 318 may have a different outer diameter than sidewall 320. Base 318 may be wider or narrower than the sidewall depending on a number of factors including the softness and distensibility of the base, the length of the base, and/or the overall width of the user's vagina. Flange 338 may have a length ranging from about 0.25 to 1 inches, preferably from about 0.25 to 0.5 inches. The length of the flange best suited to a user will depend on the distance between the anterior fourshette and the clitoris. Flange 340 may have a length ranging from 0.25 to 2 inches. The length of the flange best suited to a user will depend on the distance between the posterior fourshette and the perineum. Raised bump 342 may be positioned along the front wall at about 1 to 4 inches, preferably 2 to 3 inches from the caudal end of the device. The raised bump preferably has a diameter ranging from about 0.5 to 3 inches, preferably 1 to 2 inches and a height ranging from about 0.25 to 1 inches, preferably 0.5 to 0.75 inches. The position and size of the bump best suited to a user will depend on the position and size of the G-spot.

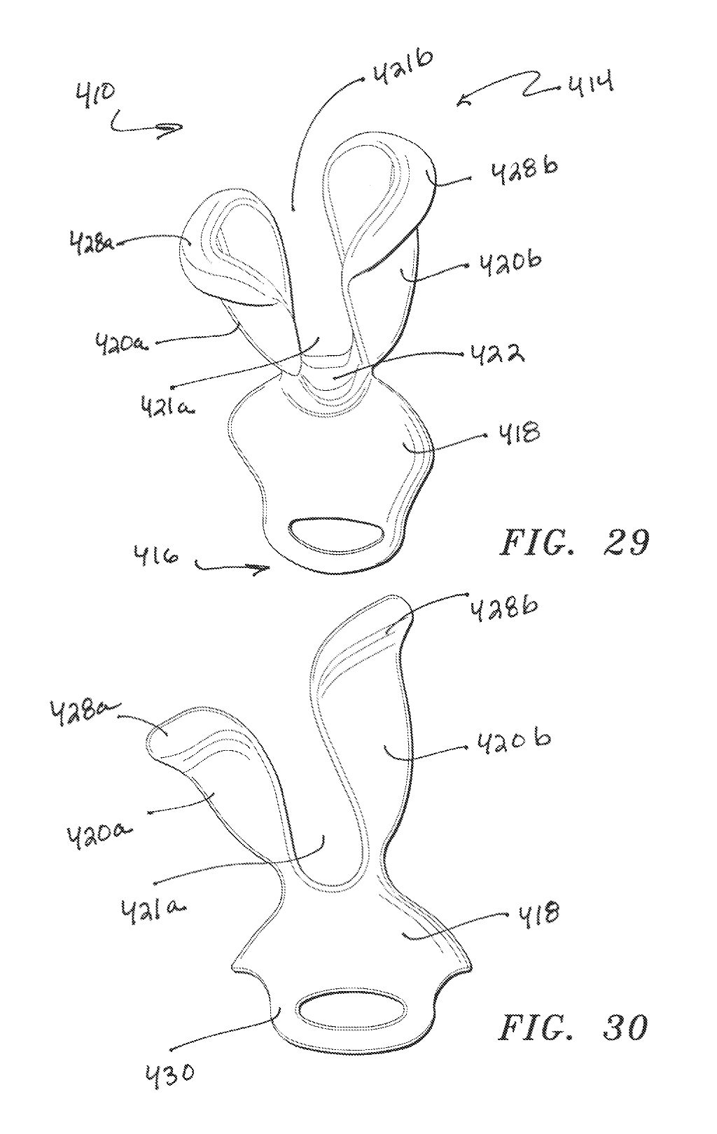

A device in accordance with another embodiment of the present invention is generally designated in FIG. 29 by the numeral 410. Device 410 is configured for use during sexual intercourse by a female user that has a cervix but can also be used by a female user that has had her cervix removed via hysterectomy. Device 410 has a generally chalice-shaped body 412 extending from a lower caudal end 416 to an upper cephalad end 414. Body 412 has a dome shaped base 418, a tubular neck or stem 419 extending upwardly from the top center of base 418, and a cup-shaped arcuate sidewall 420 extending upwardly and outwardly from stem 419. U-shaped valleys or openings 421a, 421b extend downwardly from the top edge of sidewall 420 into stem 419 on either side of device 410 to divide sidewall 420 into a front extension 420a and a rear extension 420b. The inner surface of stem 419 and inner surfaces of front and rear extensions 420a, 420b define an elongated recess 422 extending from upper end 414 to the top of base 418. Dome-shaped base 418 defines a broad central cavity 424 having a smooth concave inner surface accessible from the caudal end of device 410. Cavity 424 is configured to receive the distal end or glans of the penis for abutting contact with the concave inner surface. Base 418 extends downward along one side to form a handle 430 with an oval shaped aperture 431 therein configured to be grasped by a user's fingers for removal of the device.

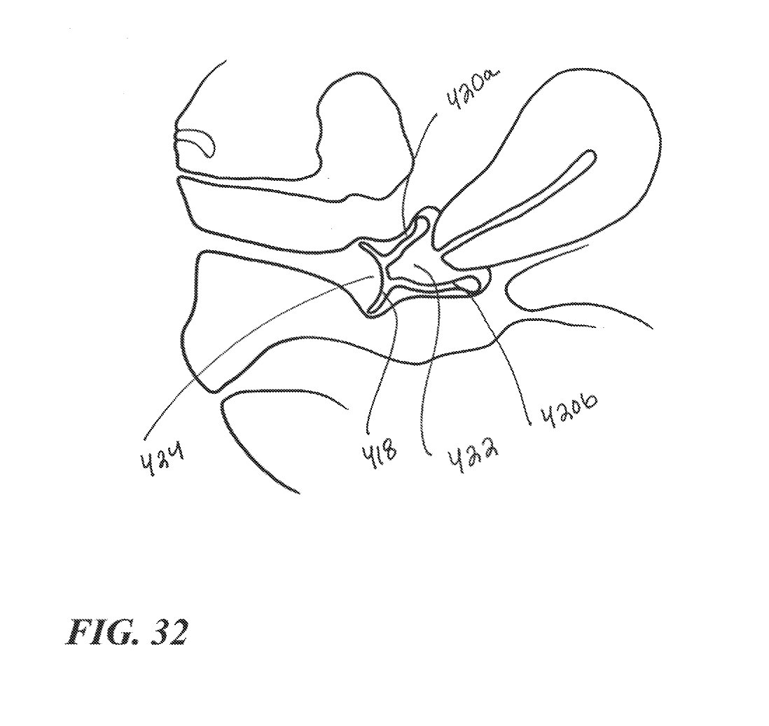

Front and rear extensions 420a, 420b are configured to generally correspond in shape with the anterior and posterior fornices of the user respectively such that an upper portion of front extension 420a can be inserted into the anterior fornices of the user (if the user has a cervix) in abutting engagement with the anterior upper vaginal wall, and an upper portion of rear side extension 420b can be inserted into the posterior fornices of the user (if the user has a cervix) in abutting engagement with the posterior upper vaginal wall. (See, FIG. 32). Front and rear extensions 420a and 420b are configured such that if the user has a cervix, the cervix may be received within recess 422 when the device is inserted into position within the upper vagina of the user. Regardless of whether or not the user has a cervix, a portion of the top and outer surfaces of extensions 420a, 420b will be positioned in abutting contact with corresponding portions of the top and side vaginal walls of the fornices and/or upper most vaginal region.

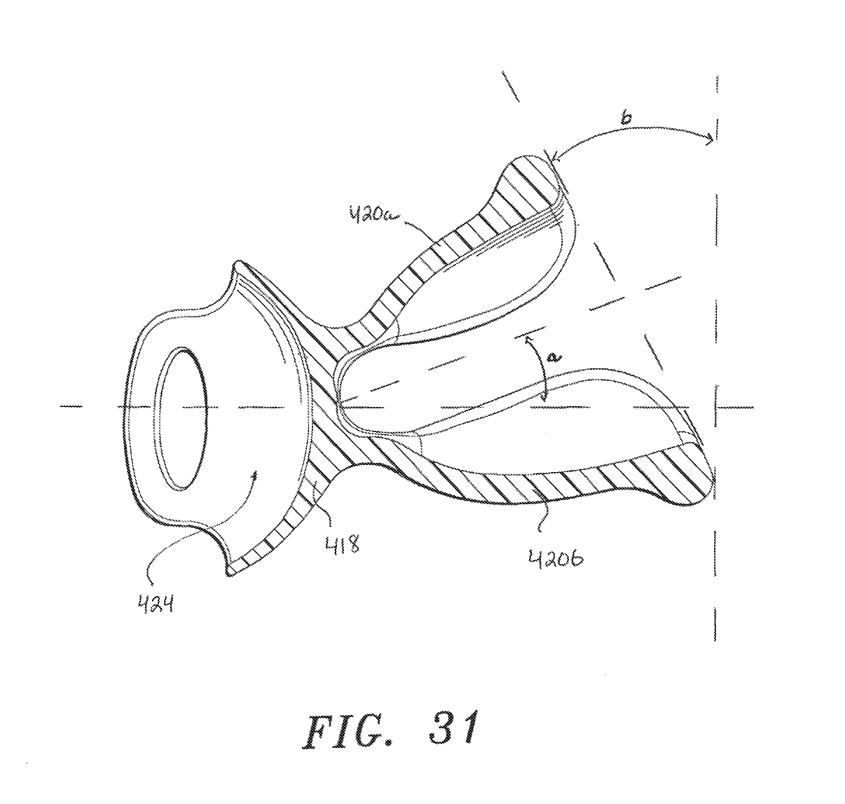

Looking specifically to FIG. 31, front and rear extensions 420a, 420b extend upwardly from stem 419 along an axis that is tilted forward an angle a relative to the central axis of base 418 to conform in shape with the relative position of the anterior and posterior fornices. Angle a preferably ranges from 5 to 20 degrees, preferably 8 to 12 degrees and most preferably about 10 degrees. In addition, rear extension 420b is longer and wider (as measured from side to side along the inner surface of extension 420b) to conform to the shape and configuration of the posterior fornices. Angle b defined by the tilt and the difference in length between extensions 420a, 420b may range from 5 to 30 degrees, preferably 12 to 25 degrees and most preferably about 20 degrees. The upper edges of each extensions 420a, 420b are rounded and flared outwardly to form upper rims 428a, 428b respectively having a thickness (as measured from the outer surface to the inner surface of the respective extensions 420a, 420b) that is greater along rims 428a, 428b than the thickness of the remaining extensions 420a, 420b. This thicker rim enables increased pressure to be applied against the upper most portions of the vaginal walls.

This configuration of device 410 enables extensions 420a, 420b to pivot laterally outward from stem 419 relative to base 418 when the bottom surface of the base is pushed upward by the penis. This lateral outward movement causes front and rear extensions 420a, 420b to apply increased pressure against the vaginal walls of the anterior and posterior fornices respectively with each thrust of the penis. Similarly, when the base is not being pushed upward, but instead being pulled downward via handle 430, extensions 420a, 420b will pivot back inward toward one another to enable easier removal of the device from the vagina.

The exterior surface of body 412 is preferably covered by a first low durometer material that is soft for contact with the penis and vaginal walls, while the core of the body is made of a second more rigid or higher durometer material to enable the device to maintain its shape in use without collapsing upon contact with the penis, vaginal wall or cervix. The more rigid material also creates a stimulating effect on the upper walls of the vagina when extensions 420a, 420b are in position within the fornices, particularly upon movement of the device due to pressure from the penis contacting the bottom surface of base 418. In addition, it is anticipated that the device may include a structural ring or plate embedded within body 412 to provide support to portions of the device. For example, a dome shaped plate may be positioned within base 418 or arcuate plates may be positioned within extensions 420a, 420b. Handle 430 can be formed integrally with an internal structural ring or plate as heretofore described or may alternatively be formed integrally with the remainder of body 412.

A mechanism may also be embedded within device 410 for making portions of the device move. For example, it is anticipated that a mechanism may be incorporated into the device, preferably within stem 419, to move extensions 420a, 420b relative to base 418 distally and/or laterally, preferably in a come hither motion, for increased pressure on the vaginal walls and/or to move extensions 420a, 420b inward for removal of the device from the vagina. Additionally, a mechanism may be embedded in device 410 to provide stimulating effects such as to cause the device to vibrate or quiver and/or to heat or cool the device.

While the particular embodiment shown has a dome shaped base with a cavity at the caudal end, it is anticipated that the caudal end may alternatively be generally flat or may include a narrower detent or channel to receive a portion of the penis as described in relation to the embodiment shown in FIGS. 10-11. In addition, the outer surface of body 412 could alternatively have any number of different surface variations including bumps, waves, detents, and the like to stimulate the vaginal walls and increase the overall surface area of the device in contact with the vaginal walls.

As discussed with regard to other embodiments, the overall size and shape of device 410 may vary to fit the anatomy of the user. In one embodiment, it is anticipated that the device will be produced in a series of different dimensions, varying in the overall length of device 410, the length and width of extensions 420a, 420b, and optionally, the width and depth of cavity 424. A physician or other healthcare provider will measure the vaginal length, cervical diameter and fornical length of the user. The device dimensioned to best correspond with these measurements will then be determined for the user. In an alternative embodiment, the measurements taken of the user could be used to manufacture a custom fit device or alternatively a mold of the user's upper vaginal region or entire vagina could be made as is known in the art and used to manufacture a custom fit device for the user. A measurement of the male partner's erect penis may also be used in determining the best overall length of device 410 and width and depth of cavity 424, or, in the alternative embodiment, be used in manufacturing a custom fit device.

In general, it is anticipated that the overall length of device 410 may range from about 0.5 to 3 inches, preferably about 2 inches, and most preferably not more than 2.5 inches. The length of the device best suited to a user will depend upon the length of the vagina, the length of the fornices, and the length of the male partner's penis. The depth of U-shaped valleys 421 (and correspondingly the depth of recess 422) may range from about 33% to about 66% of the overall length of the device and preferably is about 50% of the overall length of the device. The depth of the valleys 421 may range from about 0.25 to 2 inches, preferably about 0.75 to 1.5 inches, and most preferably about 1.0 inch. The depth of the valleys 421 best suited to a user will depend on the fornical length. The outer diameter of sidewall 420 at rims 428a, 428b will preferably range from about equal the length of valleys 421 to about twice the length of valleys 421. The outer diameter of sidewall 420 may range from about 1.0 to 2.0 inches, and most preferably about 1.5 to 1.75 inches. The outer diameter of sidewall 420 best suited to a user will depend on the fornical and cervical width of the user. The inner diameter of sidewall 420 defining recess 422 may range from about 50% to 80%, preferably about 60% to 70% of the outer diameter of sidewall 420. The inner diameter of sidewall 420 may range from about 0.5 to 1.75 inches, preferably about 1 inch. The inner diameter of sidewall 420 best suited to a user will depend on the cervical width of the user.

The outer diameter of sidewall 420 is dependent on the fornical and cervical width and is configured to enable the sidewall to fit within the fornices. Base 418 is not intended to fit within the fornices and may therefore be wider or narrower depending on a number of factors including the softness and distensibility of the base, the length of the base, the length and girth of the male partner's penis, and/or the overall width of the user's vagina.

The width of base 418 preferably has an outer diameter ranging from 1 to 3 inches, preferably about 2 inches. The height or depth of cavity 424 (measured from the bottom edge of base outside the handle area to the inner top center surface of base 418) is preferably a maximum depth at the center ranging from 0.2 to 1 inch, preferably around 0.4 to 0.5 inches and no greater than 0.5 inches. The maximum depth and width of the cavity best suited to a user will depend on the softness and distensibility of the base, the length of the base, the length and girth of the male partner's penis, and/or the overall width of the user's vagina.

While device 410 as shown in FIGS. 29-32 is configured for use during sexual intercourse, it is anticipated that the device could be modified for self-stimulation use by extending base 418 downward the full length of the lumen to form a handle. This alternative embodiment is depicted in use in FIG. 38, wherein extensions 420a, 420b and stem 419 are configured as described above, but base 418 forms an elongated handle extending from stem 419 to caudal end 416.

A device in accordance with another embodiment of the present invention is generally designated in FIG. 33 by the numeral 510. Device 510 is configured for self-stimulation by a female user that has a cervix, but may also be used by a user that has had her cervix removed via hysterectomy. Device 510 has an elongated sigmoid-shaped body 512 extending from an upper cephalad end 514 to a lower caudal end 516. The upper portion of the body is concave, curving inwardly from the upper cephalad end to about the mid-point of the device, and the lower portion of the body is convex, curving outwardly from about the mid-point to the lower caudal end 516. As best seen in FIG. 36, device 510 has a c-shaped cross-section wherein outer wall 520 is convex extending along a radius outward from a first end 560a on one side of device 510 to a second end 560b on the other side of device 510. Inner wall 562 is concave extending along a radius between first and second ends 560a, 560b of outer wall 520. Upper cephalad end 514 of the device is rounded to form an upper rim 528 extending along a radius from outer wall 520 to inner wall 562. A recess 564 is formed in outer wall 520 along the lower portion of the device configured to conform in shape to a thumb or finger of a user to assist in holding and maneuvering the device.

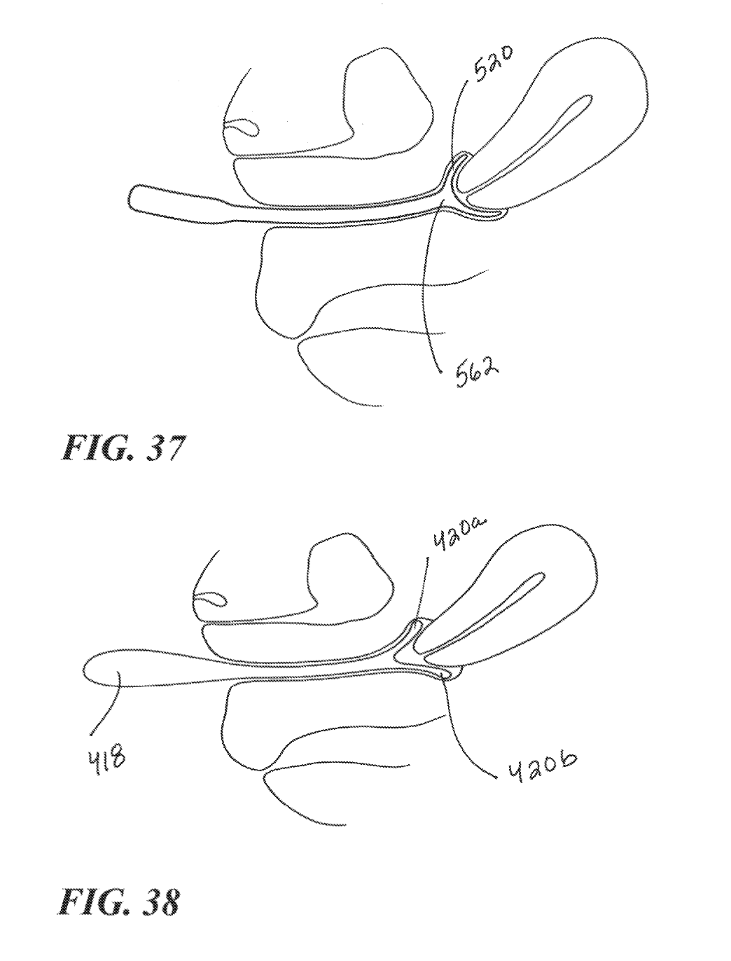

As shown in FIG. 37, the upper concave portion of the device is configured to conform in shape to the fornices such that it can be inserted into portions of the fornices with rim 528 and outer wall 520 positioned in abutting engagement or contact with the upper vaginal walls and inner wall 562 surrounding a portion of the cervix. Once in this position, the user can manually move lower end 516 back and forth causing rim 528 and upper portions of outer wall 520 to move in the opposite direction so as to apply pulses of increased pressure against the vaginal walls simulating a come hither motion.

As heretofore described with regard to the embodiments of FIGS. 19-28, lower caudal end 516 may also include tail-shaped flanges (not shown) extending from the front and/or rear of caudal end to stimulate the clitoris and/or perineum respectively. In addition, the lower portion of device 510 may include an outwardly extending bump (not shown) positioned in an area corresponding with that of the G-spot when the device is positioned within the vagina.

The exterior surface of body 512 is preferably covered by a first low durometer material that is soft for contact with the vaginal walls, while the core of the body is made of a second more rigid or higher durometer material to enable rigid movement of the device and to enable the device to maintain its shape in use without collapsing upon contact with the vaginal walls. The more rigid material also creates a stimulating effect on the upper walls of the vagina with contact. In addition, it is anticipated that the device may include a structural plate embedded within body 512 to provide rigidity and support to the body. Also, the exterior surface of body 512 could alternatively have any number of different surface variations including bumps, waves, detents, and the like to stimulate the vaginal walls and increase the overall surface area of the device in contact with the vaginal walls.

A mechanism may also be embedded within the device for making portions of the device move. For example, it is anticipated that a mechanism may be incorporated into the device to move the upper portion of the device distally and/or laterally outward, preferably in a come hither motion, for increased stimulation of the vaginal walls. Additionally, a mechanism may be embedded in device 510 to provide stimulating effects such as to cause the device to vibrate or quiver and/or to heat or cool the device.

The overall size and shape of device 510 may vary to fit the anatomy of the user as previously described. In one embodiment, it is anticipated that device 510 will be produced in a series of different dimensions, varying in the overall length and width of device 510. A physician or other healthcare provider will measure the vaginal length, cervical diameter and fornical length of the user. The device dimensioned to best correspond with these measurements will then be determined for the user. In an alternative embodiment, the measurements taken of the user could be used to manufacture a custom fit device or alternatively a mold of the user's upper vaginal region or entire vagina could be made as is known in the art and used to manufacture a custom fit device for the user.

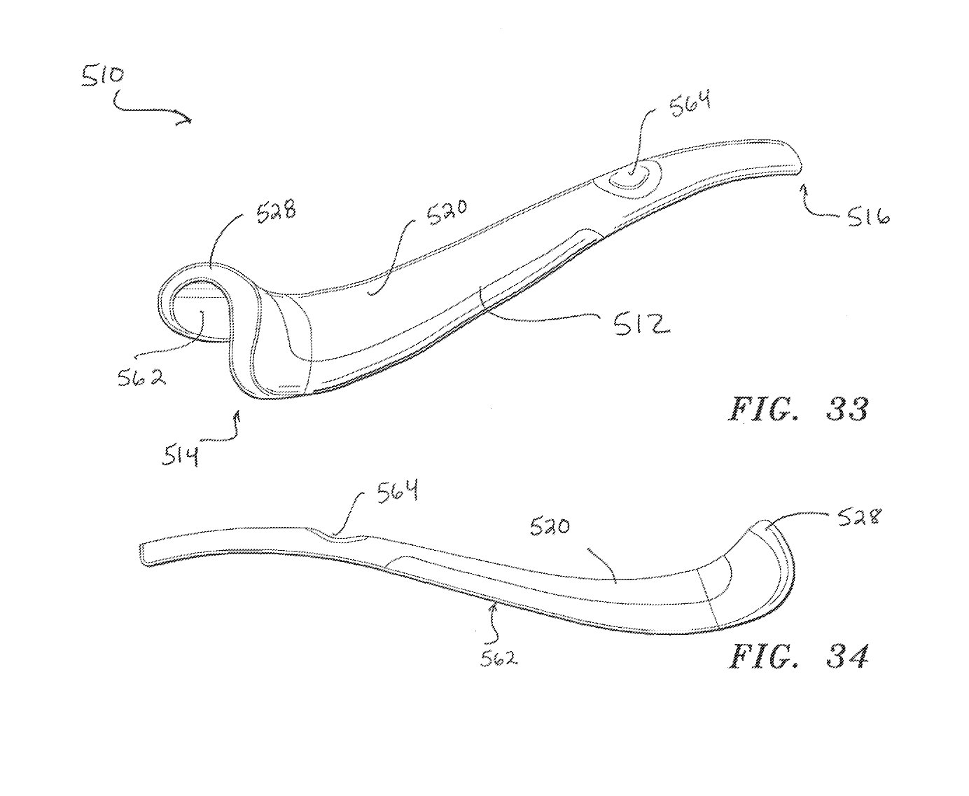

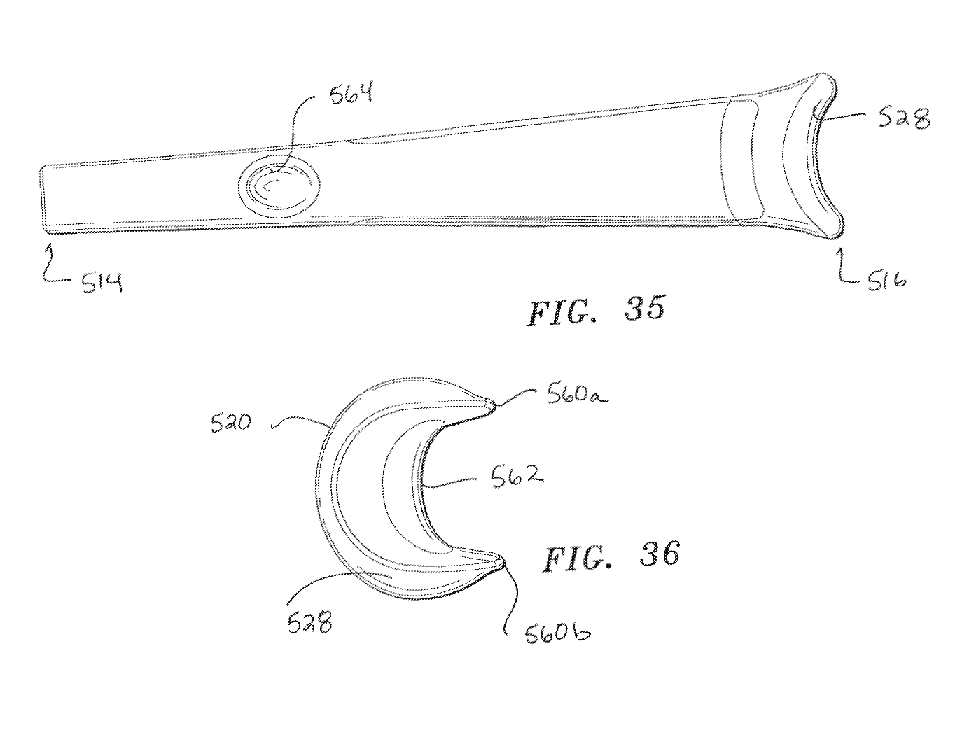

In general, it is anticipated that the overall length of the device may range from about 3 to 12 inches, preferably about 6 to 10 inches, and most preferably about 7 to 9 inches. The length of the device best suited to a user will depend upon the length of the vagina. In the embodiment shown in FIGS. 33-35, the device is tapered inwardly toward the caudal end 516 such that the outer diameter of the device decreases from the cephalad end to the caudal end. The diameter of outer sidewall 520 at the cephalad end may range from about 0.75 to 2.5 inches, preferably about 1.5 to 2.2 inches, and most preferably about 1.5 to 2 inches. The diameter of inner sidewall 562 best suited to a user will depend on the fornical and cervical width of the user. The diameter of inner sidewall 562 may range from about 50% to 85%, preferably about 65% to 75% of the diameter of outer sidewall 520. The diameter of inner sidewall 562 may range from about 0.5 to 2 inches, preferably about 1.25 to 1.5 inches. The diameter of inner sidewall 562 best suited to a user will depend on the cervical width of the user.

All embodiments of the device of the present invention may include means for causing the device or portions thereof to vibrate, spasm, quiver, message, rotate, expand or contract, extend caudally or otherwise move. These means may include any arrangement of electronic and/or electromechanical components as is known in the art for generating such motion, including those arrangements used in conjunction with vibrators and other sex toys. These components may include a motor or selenoid having an actuator for generating vibrations or other motion, an electronic controller, and a power source, such as batteries (chargeable or rechargeable), electrically coupled to the motor or selenoid via the controller. A wireless remote may also be included to enable the user to remotely control the power and/or operation of these components. These components may be included within a stimulation ring, structural ring, structural plate or other protected component embedded within the device. In addition, projections extending through the exterior surface of the device may include means for individual motion, such as rotation or vibration. The motion may be adjusted to different speeds, intensities and patterns of vibration or message, for example. Other components could be included within the device, such as a component to regulate the temperature via heating or cooling the device, an audio component such as for sound recordings, and/or an illumination or lighting component such as to glow in the dark.

It is also anticipated that the device may include a void area which can be filled by the user with lubricant and a dispensing valve configured to release the lubricant with movement of the device so as to moisten the vagina during intercourse or self-stimulation.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A device for sexual stimulation and/or treating vaginal atrophy, said device comprising:
a body extending from an upper cephalad end to a lower caudal end, wherein said cephalad end is configured to be inserted into at least a portion of the upper vaginal region of a female user for contact with at least a portion of the vaginal walls surrounding the upper vaginal region.

2. A device according to claim 1, wherein an upper section of the device adjacent the cephalad end is configured such that it can be inserted into said upper vaginal region with an outer surface of said upper section positioned in abutting contact against a corresponding surface of the vaginal walls surrounding the region.

3. A device according to claim 2, wherein said cephalad end is configured such that it can be inserted into one or more portions of the fornices of the female user.

4. A device according to claim 3, wherein said cephalad end is configured such that it can be inserted into at least a portion of the anterior and/or posterior fornices of the female user.

5. A device according to claim 1, wherein said body comprises a base with at least one extension extending upwardly from the base, said extension having an outer surface and an inner surface and wherein said extension is configured to be inserted into at least a portion of the fornices of a female user such that the outer surface is positioned in abutting contact with a portion of the upper vaginal wall in the fornices and such that the inner surface is positioned facing the cervix of the female user.

6. A device according to claim 5, wherein said at least one extension extends upwardly from a front portion of the base and is configured to fit within the anterior fornices

7. A device according to claim 5, wherein said at least one extension extends upwardly from a rear portion of the base and is configured to fit within the posterior fornices.

8. A device according to claim 5, wherein said at least one extension is ring-shaped, configured to fit around the cervix and rest within at least a portion of the anterior, posterior and lateral fornices.

9. A device according to claim 5, wherein said at least one extension has a dome shaped head, configured to rest within the upper vaginal region of a female user that has had a hysterectomy in abutting contact with the surrounding anterior, posterior and lateral vaginal walls.

10. A device according to claim 5, wherein said base is configured for contact with a penis during penetration into the vagina of the female user.

11. A device according to claim 10, wherein said device is configured such that when the penis comes into contact with said base and presses against the base, the cephalad end of the device is displaced upwardly and/or outwardly such that the at least one extension applies pressure against the upper vaginal walls.

12. A device according to claims 10, wherein said device is configured to distend laterally when the penis comes into contact with said base and presses against the base.

13. A device according to claim 10, wherein said base is at least partially formed of a first low durometer material that is easily displaced upon contact with a penis.

14. A device according to claim 10, wherein said base comprises a central detent, slot or passageway for receiving a portion of a penis during penetration into the vagina.

15. A device according to claim 1, wherein said body comprises a base with a concave bottom surface configured for abutting contact with a penis penetrating the vagina of a female user, a tubular stem extending upwardly from a central portion of the base, and arcuate front and rear extensions extending upwardly and outwardly from the stem.

16. A device according to claim 15, wherein said front and rear extensions are configured such that an upper portion of each said front and rear extensions can fit within the anterior fornices and posterior fornices respectively of a female user and rest in abutting contact with portions of the vaginal walls in said fornices.

17. A device according to claim 16, wherein said front and rear extensions are configured to pivot laterally outward at a pivot point when the bottom surface of the base is pushed upward by a penis penetrating the vagina of a female user causing the front and rear extensions to apply pressure against the vaginal walls of the anterior and posterior fornices respectively.

18. A device according to claim 5, wherein said body is configured to extend the entire length or lumen of the vagina.

19. A device according to claim 18, wherein said caudal end of the device is configured to enable a user to grasp and move the device.

20. A device according to claim 19, wherein said device comprises a protrusion extending outwardly from the front of the device in an area corresponding with the G-spot of a female user, such that the protrusion may come into abutting contact with the G-spot when the device is positioned within the vagina.

21. A device according to claim 19, wherein said device comprises a projection extending from the front of the caudal end of the device configured to rest in abutting engagement or contact with the clitoris of a female user when the device is inserted into the vagina.

22. A device according to claim 19, wherein said device comprises a projection extending from the rear of the caudal end of the device configured to rest in abutting engagement or contact with the perineum of a female user when the device is inserted into the vagina.

23. A device for sexual self-stimulation, said device comprising:
a body extending from an upper cephalad end to a lower caudal end, wherein an upper section of the device adjacent the cephalad end is configured such that it can be inserted into the upper vaginal region of a female user with an outer surface of said upper section positioned in abutting contact against a corresponding surface of the vaginal walls surrounding the region.

24. A device according to claim 23, wherein said cephalad end is configured such that it can be inserted into one or more portions of the fornices of the female user.

25. A device according to claim 24, wherein said cephalad end is configured such that it can be inserted into at least a portion of the anterior and/or posterior fornices of the female user.

26. A device according to claim 25, wherein said device is configured to move the upper section of the device laterally to apply pulses of pressure against one or more portions of the upper vaginal walls once in place within the upper vaginal region.

27. A device for sexual stimulation and/or treating vaginal atrophy, said device comprising:
a body extending from an upper cephalad end to a lower caudal end, wherein said cephalad end is configured to be inserted into at least a portion of the upper vaginal region of a female user for contact with at least a portion of the vaginal walls surrounding the upper vaginal region.

28. A device according to claim 27, wherein an upper section of the device adjacent the cephalad end is configured such that it can be inserted into said upper vaginal region with an outer surface of said upper section positioned in abutting contact against a corresponding surface of the vaginal walls surrounding the region.

29. A device according to claim 28, wherein said cephalad end is configured such that it can be inserted into one or more portions of the fornices of the female user.

30. A device according to claim 29, wherein said cephalad end is configured such that it can be inserted into at least a portion of the anterior and/or posterior fornices of the female user.

31. A device according to claim 30, wherein said device has a C-shaped cross-section and a sigmoid-shaped elongated body.

32. A device according to claim 31, wherein said device is configured such that the lateral movement of the caudal end of the device results in movement of the cephalad end against the vaginal walls simulating a come hither motion.
